(19) United States
(12) Patent Application Publication
(10) Pub. No.: US 2002/0087675 A1
(43) Pub. Date: Jul. 4, 2002

(54) Media-distribution-resource management apparatus and storage medium

(75) Inventors: Yoshihiro Yoshii, Tokyo (JP); Yasuhiko Hongo, Tokyo (JP); Susumu Miyao, Tokyo (JP); Takahiro Endo, Tokyo (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/935,831

(22) Filed: Aug. 24, 2001

(30) Foreign Application Priority Data
Dec. 28, 2000 (JP) 2000-403479

(51) Int. Cl. G06F 15/173

(52) U.S. Cl. 709/223

(57) ABSTRACT

A resource-utilization-information management unit manages shared-resource information about both available network resources and available media-distribution-system resources. A shared-resource management unit distributes or redistributes the shared resources based on a resource-utilization request from each content distributor. A distribution management unit performs both the reservation management and distribution management of media distribution for each content server within the scope of a resource-utilization right distributed or re-distributed by the shared-resource management unit.

### BACKGROUND OF THE INVENTION

1. Field of the Invention

The present invention relates to a technology for effectively using shared resources in a media distribution service that uses a computer network and shares communications resources, including a line band, such as a technology for a content provider providing video contents through the Internet.

2. Description of the Related Art

In services, such as a service where a content provider provides video contents through the Internet, there are the following two service operation forms.

One is an exclusive service. In this case, as shown in FIG. 1A, a content provider possesses both a dedicated line to the Internet and a WWW server at his/her own expense.

The other is a shared service. In this case, as shown in FIG. 2, a WWW server or content server is installed in a specific data center and several content provides shares both an access line to the Internet and the WWW server.

Of the two services, the exclusive service has a problem that a line band is guaranteed but line cost is high. As shown in FIG. 1B, the exclusive service also has another problem that a line utilization rating is low except for a peak hour. In this service, since basically a content provider himself/herself have to operate and to maintain the server, there is the possibility that the operation scale and cost of the system may become large. Therefore, the exclusive service has another problem that only a limited number of providers can provide this service.

However, in the shared service, since a line is shared by a plurality of providers, a high overall line utilization rating can be expected. In this service, since a WWW server is also operated in a common data center, costs, such as a maintenance cost and the like, can be suppressed and simultaneously the operation scale and cost of the system can be reduced. Therefore, the shared service has an advantage that even a small-scale content provider can provide this service, and the increase in number of providers using this service can be expected.

Although as described above, a shared service is promising in the future, this service has the following two problems.

The first problem is that, for example, if each content distributor uses a communications resource within the limits of communications resource value that he/she virtually and individually sets, each content distributor cannot distribute pictures and the like beyond his/her individually set communications resource value even if there is still a surplus in reality.

However, if each content distributor uses the communications resource within the limits of the maximum value of the real resource, this problem may be solved. For example, this is the case where a specific content distributor distributes pictures to the utmost limit of the communications resource.

However, in such a case, the distributor monopolizes the video distribution resource and the other content providers that share the communications resource cannot distribute any picture, which is the second problem.

As described above, the conventional shared service system has the problem that a shared resource cannot be effectively utilized in a method of utilizing a specific resource within the limits of a set resource. The conventional shared service system also has the problem that the minimum necessary resource cannot be guaranteed in a method of utilizing a specific resource to the utmost limits of the real resource.

It is an object of the present invention to simultaneously implement the effective utilization of a shared resource and the guaranty of the minimum necessary resource.

### SUMMARY OF THE INVENTION

It is an object of the present invention to provide a mechanism for setting “the minimum guaranteed number of distribution” for each content and efficiently utilizing a line by managing a communications resource (hereinafter simply called “resource”) using a resource management server.

The resource management server of the present invention provides the following functions.

(a) A content distributor (hereinafter called a “provider”) utilizes a reservation function to designate a time zone and a resource management server manages “the minimum guaranteed number of distribution” of each provider as the “number of distribution to be reserved”.

(b) A resource management server aims to improve the utilization rating of a shared resource by managing the reservation situation of all providers that use the shared resource.

### BRIEF DESCRIPTION OF THE DRAWINGS

FIG. 1A shows the system configuration of video-distribution-resource management by an exclusive service;

FIG. 1B shows the band utilization form of video-distribution-resource management by an exclusive service;

FIG. 2 shows the system configuration of video-distribution-resource management by a shared service;

FIG. 3A shows a function to set a minimum guaranteed number of distribution for each content;

FIG. 3B shows a function to check the number of available lines based on the reservation situation of each time zone and to allocate lines to viewers without reservations;

FIG. 3C shows a function to adjust the system so as to continue to use the content after a time zone is over;

FIG. 4 shows the overall system configuration of one preferred embodiment of the present invention;

FIG. 5 shows the configuration of a video-distribution-resource management system;

FIG. 6 shows the data structure (No. 1) of the preferred embodiment of the present invention;

FIG. 7 shows the data structure (No. 2) of the preferred embodiment of the present invention;

FIG. 8 is a system flowchart (resource utilization registration);

FIG. 9 is a system flowchart (program viewing No. 1);

FIG. 10 is a system flowchart (program viewing in the case where there is no reservation in an accessed time zone);

FIG. 11 is a system flowchart (program viewing No. 1 in the case where a program does not finish unless a time zone shifts);

FIG. 12 is a system flowchart (program viewing in the case where a time zone shifts while viewing a program);

FIG. 13 is a system flowchart (program reservation No. 1);

FIG. 14 is a system flowchart (reservation registration No. 1);

FIG. 15 is a system flowchart (reservation-number collection process);

FIG. 16 is a system flowchart (reservation cancellation No. 1);

FIG. 17 is a system flowchart (membership registration);

FIG. 18 shows a screen transition diagram (No. 1);

FIG. 19 shows a main screen (No. 1);

FIG. 20 shows a member information input screen;

FIG. 21 shows a program selection screen (No. 1);

FIG. 22 shows a program-airing screen;

FIG. 23 shows a re-access request screen;

FIG. 24 shows a reservation guidance screen;

FIG. 25 shows a reservation addition notice screen;

FIG. 26 shows a cutting notice screen;

FIG. 27 shows a cutting screen;

FIG. 28 shows a reservation information input screen (No. 1);

FIG. 29 shows a reservation confirmation screen (No. 1);

FIG. 30 shows a reservation completion screen (No. 1);

FIG. 31 shows a reservation cancellation screen (No. 1);

FIG. 32 shows a reservation cancellation confirmation screen;

FIG. 33 shows a membership registration screen;

FIG. 34 shows a registration confirmation screen;

FIG. 35 shows a membership management table;

FIG. 36 is a system flowchart (program viewing No. 2 (reservation ID version));

FIG. 37 is a system flowchart (program viewing No. 2 in the case where a program does not finish unless a time zone shifts (reservation ID version));

FIG. 38 is a system flowchart (program reservation No. 2 (reservation ID version));

FIG. 39 is a system flowchart (program registration No. 2 (reservation ID version));

FIG. 40 is a system flowchart (reservation cancellation No. 2 (reservation ID version));

FIG. 41 is a screen transition diagram (No. 2 (reservation ID version));

FIG. 42 shows a main screen (No. 2) (reservation ID version));

FIG. 43 shows a program selection screen (No. 2)(reservation ID version));

FIG. 44 shows a reservation information input screen (No. 2)(reservation ID version));

FIG. 45 shows a reservation confirmation screen (No. 2)(reservation ID version));

FIG. 46 shows a reservation completion screen (No. 2)(reservation ID version));

FIG. 47 shows a reservation cancellation screen (No. 2)(reservation ID version));

FIG. 48 shows a reservation ID management table;

FIG. 49 shows one configuration of a resource management server.

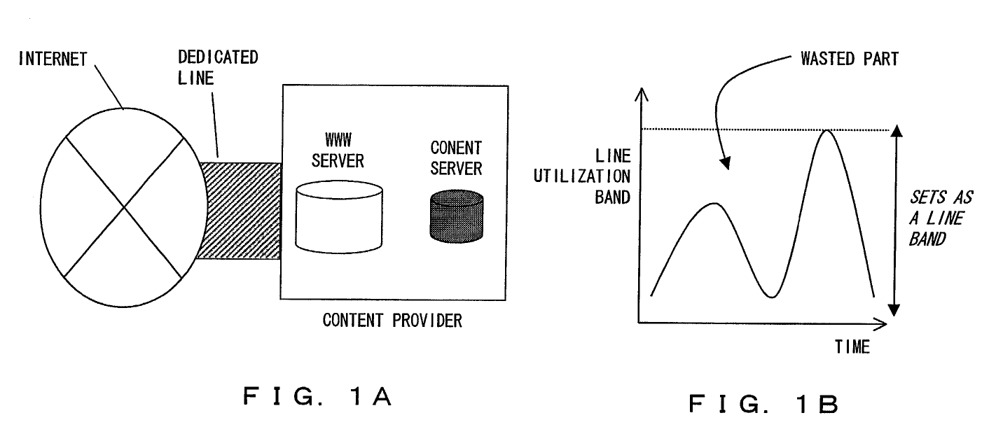

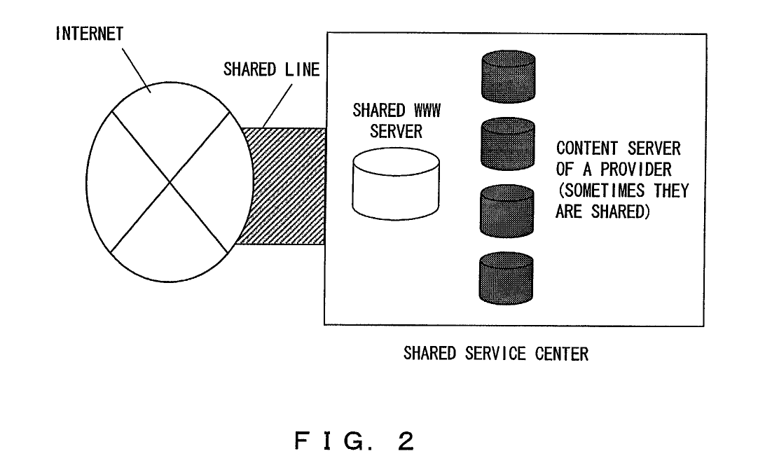

### DESCRIPTION OF THE PREFERRED EMBODIMENTS

The preferred embodiments of the present invention are described in detail below with reference to the drawings.

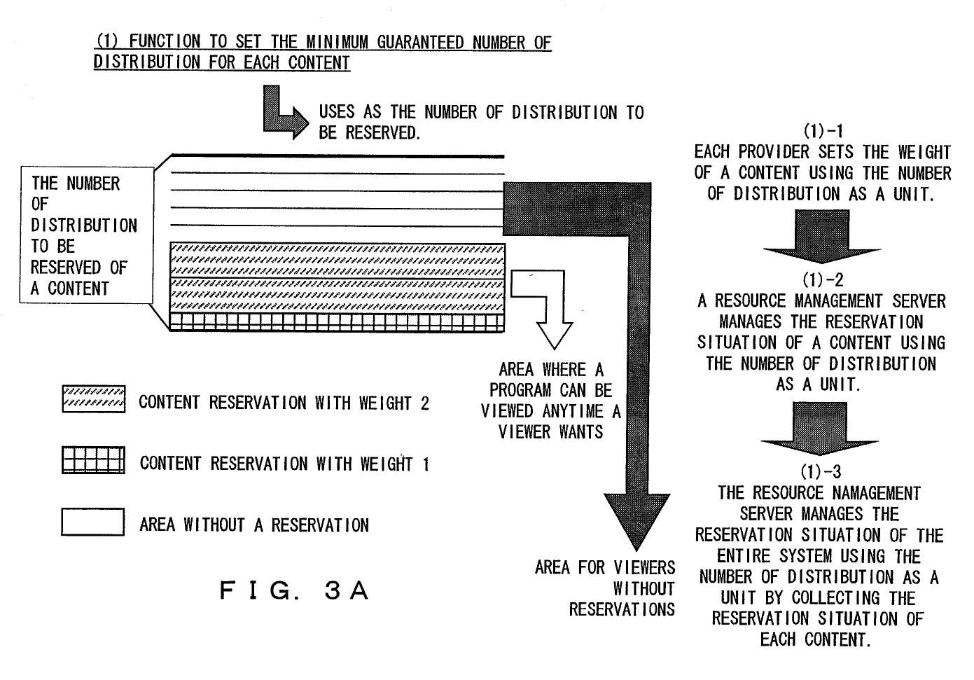

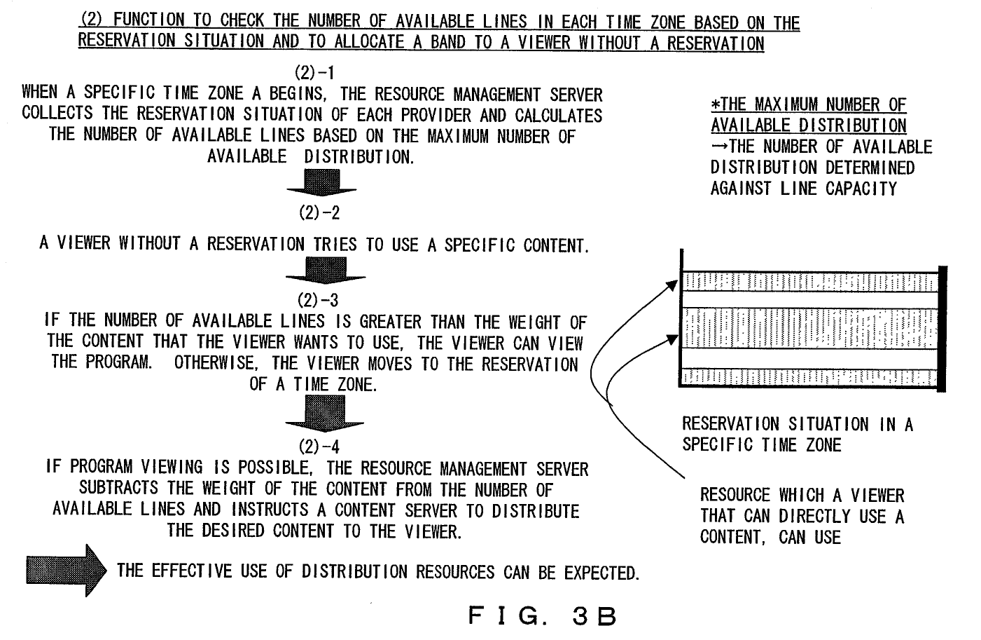

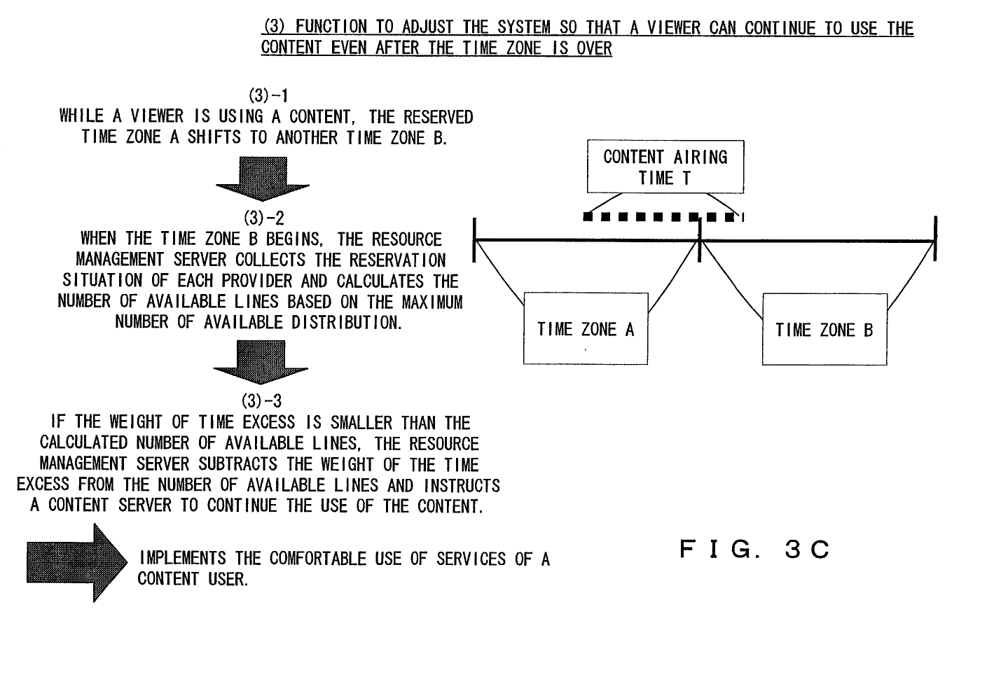

First, the summary is described in detail. Specifically, the resource management server of the present invention implements the following three functions (1) to (3). Each function is described in detail with reference to the basic configurations FIGS. 3A through 3C.

(1) Provision of a function to set the minimum guaranteed number of distribution of each content (FIG. 3A)

Each provider sets the weight of each content using the number of distribution as a unit by this function (1) ((1)-1).

The resource management server manages the reservation situation of each content using the number of distribution as a unit ((1)-2).

The resource management server also manages the reservation situation of the entire system using the number of distribution as a unit by collecting the reservation situation of each content ((1)-3).

(2) Provision of a function to check the number of available lines based on the reservation situation of each time zone and to allocate a band to a viewer without reservation (FIG. 3B)

In a specific time zone A, the resource management server collects the reservation situation of each provider and calculates the number of available lines based on the maximum number of available distribution ((2)-1). The maximum number of available distribution is the number of available distribution that is determined against the capacity of a line connected to the Internet.

In this case, a case where a viewer without a reservation uses a specific content is assumed ((2)-2).

In this case, if the number of available lines is equal to or more than the weight (number of distribution) of a content that a viewer wants to view, the viewer can view the program. If the number is less than the weight, a specific time zone is reserved ((2)-3).

If the program can be viewed, the resource management server subtracts the weight of the content from the number of available lines and instructs a content server for distributing the content to distribute the content to the viewer ((2)-4).

By the function (2), a distribution resource can be effectively used.

(3) Provision of a function to adjust the system in such a way that a content can be used continuously even after a viewing time zone is over (FIG. 3C)

It is assumed that while a viewer is using a specific content, a reserved time zone A shifts to another unreserved time zone B ((3)-1).

When the time zone B begins, the resource management server collects the reservation situation of each provider and calculates the number of available lines based on the maximum number of available distribution ((3)-2).

If the weight of the time excess is smaller than the calculated number of available lines, the resource management server subtracts the weight of the time excess from the number of available lines and instructs the content server to enable the viewer to continue to use the content ((3)-3).

By the function (3), a content user can comfortably receive services.

The functions described above in (1) to (3) are described in detail below.

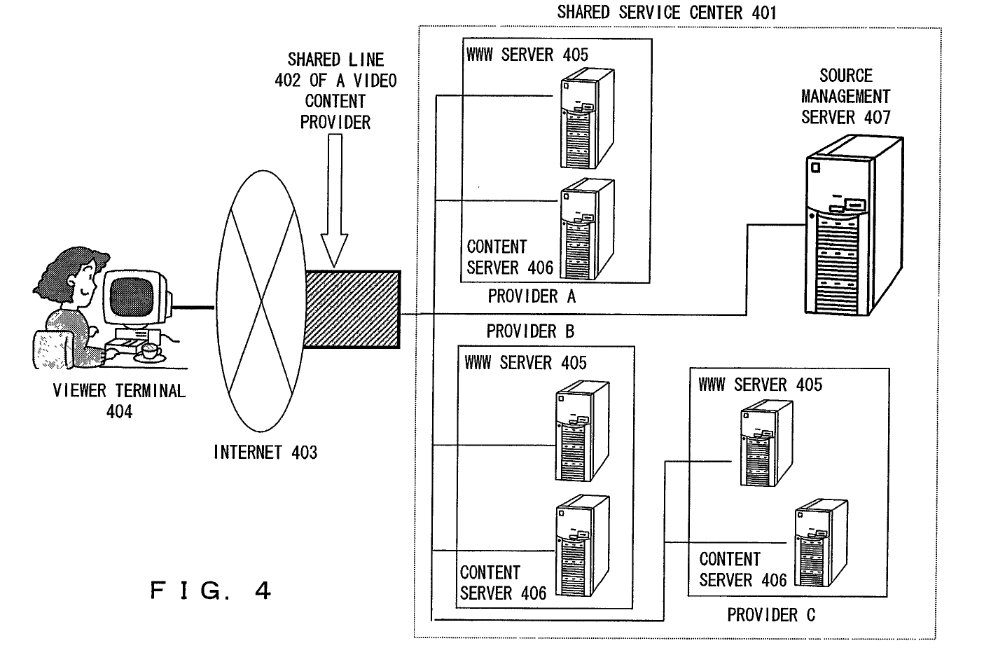

FIG. 4 shows the entire system configuration of the preferred embodiment of the present invention.

Each viewer accesses the Internet 403 from a viewer terminal 404 and receives the distribution of a video content from a shared service center 401 connected to a shared line 402.

The shared service center 401 comprises a WWW server 405 and a content server 406 for each provider. A browser application executed in the viewer terminal 404 accesses the WWW server 405 of each provider by an HTTP (hypertext transfer protocol) method, is connected to the content server 406 through the WWW server 405 and receives the distribution of a video content. The system can also be configured in such a way that one WWW server 405 can be shared by a plurality of providers.

A resource management server 407 connected to both the WWW server 405 and content server 406 of each provider through a LAN (Local Area Network) collectively manages resources used when each provider distributes a video content. Communications between the resource management server 407 and content server 406 are conducted, for example, by a HTTP method (or more popular TCP/IP method).

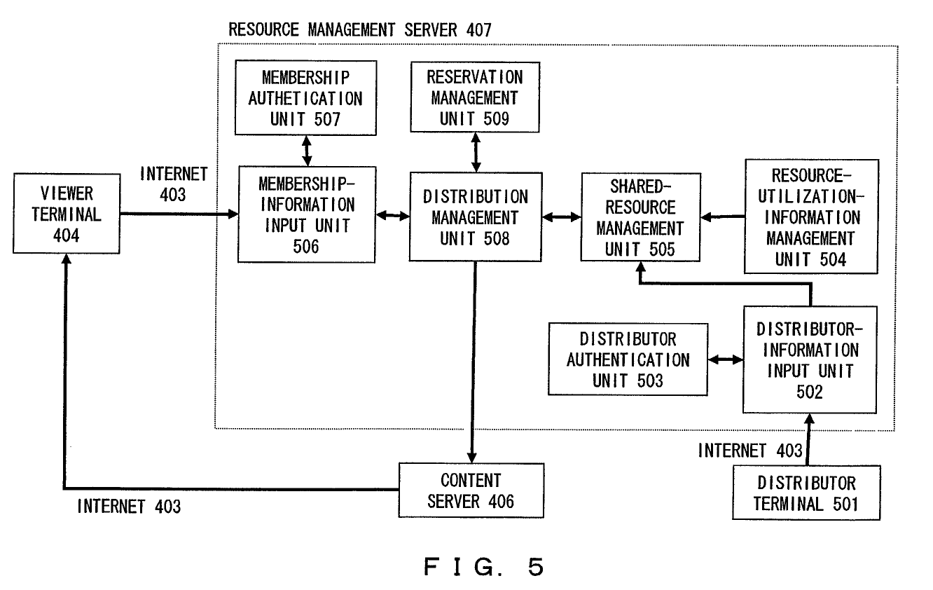

FIG. 5 shows the functional configuration of the resource management server 407.

This server is a general-purpose computer comprising a CPU, a main memory, an auxiliary storage device, a network communications device and the like. The server can implement functions represented by 502 to 509 in FIG. 5 by running a prescribed resource management program.

In FIG. 5, a resource utilization information management unit 504 manages information about shared resources, such as available network resources, the resources of the content server 406 and the like. More specifically, the resource utilization information management unit 504 is provided with at least both a server resource management function and a network resource management function. The server resource management function manages the server resource information of the content server 406. The network resource management function manages network resource information for video distribution.

A shared resource management unit 505 distributes or re-distributes a shared resource to a distribution management unit 508, which is described later, installed in each content distributor, in response to a resource utilization request from the distributor. More specifically, the shared resource management unit 505 is provided with a resource utilization information extraction function, a shared resource availability display function, a resource utilization information input function, a shared resource distribution function, a shared resource utilization amount extraction function and a shared resource re-distribution function. The resource utilization information extraction function extracts available resource information from the resource utilization information management unit 504. The shared resource availability display function displays available shared resource information for a content distributor. The resource utilization information input function makes the content distributor input a resource utilization request. The shared resource distribution function distributes the utilization right of a shared resource in a specific time period to the distribution management unit 508 installed in each content distributor, based on information obtained by both the resource utilization information extraction function and resource utilization information input function in each time zone. The shared resource utilization amount extraction function extracts the utilization situation of shared resources in a specific time zone. The shared resource re-distribution function re-distributes the utilization right of an unused shared resource to the distribution management unit 508, based on both the utilization situation and a distribution request that is extracted from the distribution management unit 508 in a specific time period.

The distribution management unit 508 performs both the reservation management and distribution management of each content server 406 within the scope of a resource utilization right distributed or re-distributed by the shared resource management unit 505. More specifically, the distribution management unit 508 is provided with an available reservation candidate display function, a distribution reservation input function, a distribution reservation management function, a direct viewing reception function, a shared resource confirmation function, a direct viewing permitting function and a distribution instructing function. The available reservation candidate display function displays available content candidates within the scope of a utilization right distributed from the shared resource management unit 505. The distribution reservation input function makes a viewer (member) select at least one or more content to be distributed from the displayed candidates. The distribution reservation management function performs the distribution reservation of a viewer, based on the input information. The direct viewing reception function makes a viewer without reservation input a distribution request within a content distribution time. The shared resource confirmation function makes the shared resource management unit 505 check that an unused shared resource is available, based on the input information. The direct viewing permitting function permits viewing within the content distribution time, based on the utilization right re-distributed by the shared resource management unit 505. The distribution instructing function instructs the content server 406 to distribute a content to viewers, to which the direct distribution is permitted, of both viewers that reserve the content distribution and viewers without reservations.

Both a distributor information input unit 502 and a distributor authentication unit 503 manages information about a content distributor that wants to use a shared resource. The distributor information input unit 502 makes a content distributor that wants to use a shared resource input information about the distributor itself. The distributor authentication unit 503 authenticates a content distributor based on the input information.

Both a member information input unit 506 and a membership authentication unit 507 manage information about members, which are viewers. The member information input unit 506 makes a member that wants to view a program input information about the member itself. The membership authentication unit 507 authenticates a member based on the input information.

In the configuration described above, although information communications between a viewer terminal 404 or a distributor terminal 501 and a resource management server 407 is not mentioned in the following description, the communications are conducted by a HTTP method through a WWW server unit, which is installed in the resource management server 407 and is not shown in FIG. 5.

The operation of a preferred embodiment in which members are registered and services are used is described below.

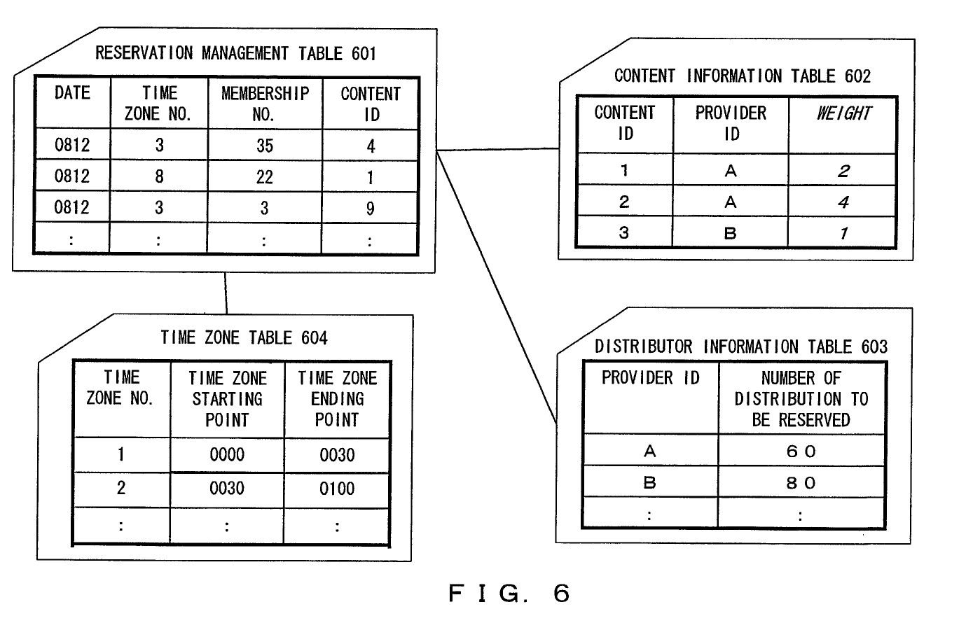

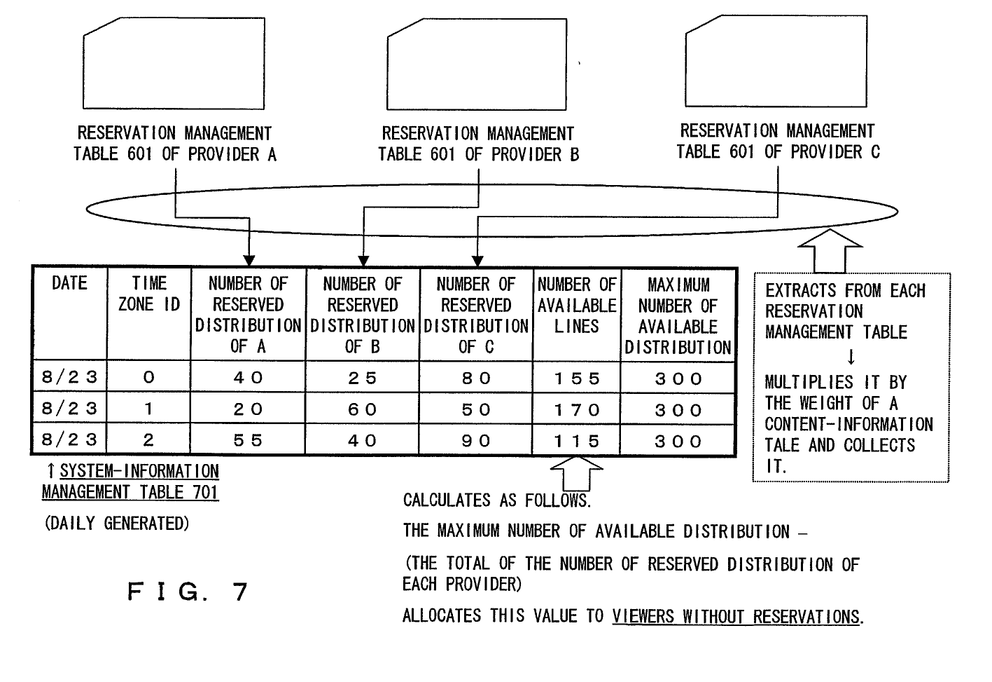

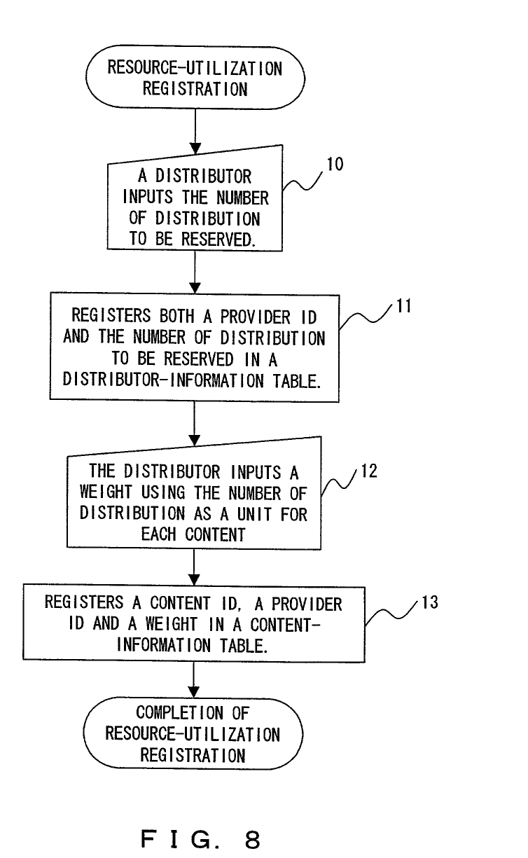

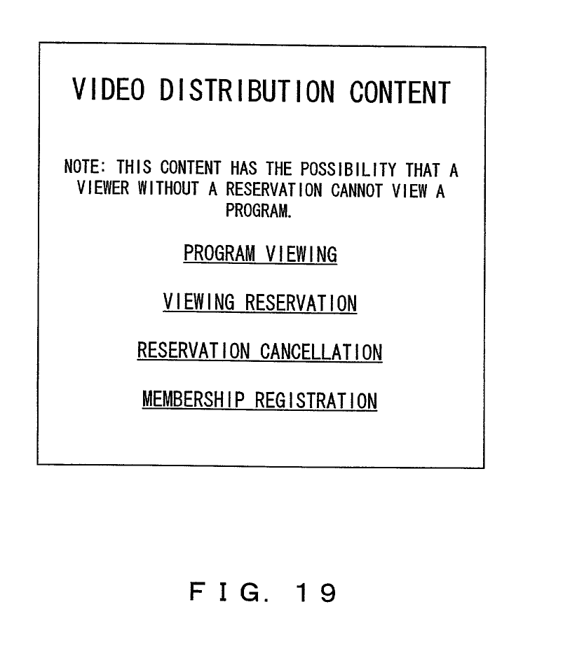

FIGS. 6 and 7 shows the data structure of the present invention. FIGS. 8 through 17 are the system flowcharts of a preferred embodiment in which viewers are registered as members and services are used. FIG. 18, FIGS. 19 through 34 and FIG. 35 show the screen transition, screen examples and a member management table, respectively.

The operation is described with reference to these drawings.

In FIG. 5, a content distributor is connected to the WWW server unit, which is not shown in FIG. 5, in the resource server 407 from the distributor terminal 501 through the Internet 403. Then, the content distributor accesses the distributor information input unit 502 through the WWW server unit. At this moment, the distributor information is inputted to the distributor information input unit 502. The distributor authentication unit 503 authenticates the distributor based on the distributor information. If the distributor is authenticated, the distributor is connected to the shared resource management unit 505.

FIG. 8 is a system flowchart showing a process for making a content distributor register the use of resources. This flow is implemented by the unit 505 executing a control program. The functions implemented by this flow correspond to the resource utilization information extraction function, available shared resource display function, resource utilization information input function and shared resource distribution function that are provided in the shared resource management unit 505.

FIG. 8 is a system flowchart showing a process for making a content distributor register the use of resources. First, the shared resource management unit 505 makes a content distributor input the number of distribution to be reserved (step 10).

Then, as shown in FIG. 6, the shared resource management unit 505 records both a provider (content distributor) ID and the number of distribution to be reserved in the distributor information table 603 that the unit 505 manages (step 11).

Then, the shared resource management unit 505 makes the content distributor input the weight of each content using the number of distribution as a unit (step 12).

Then, as shown in FIG. 6, the shared resource management unit 505 records the content ID, provider ID and weight in a content information table 602 (step 13).

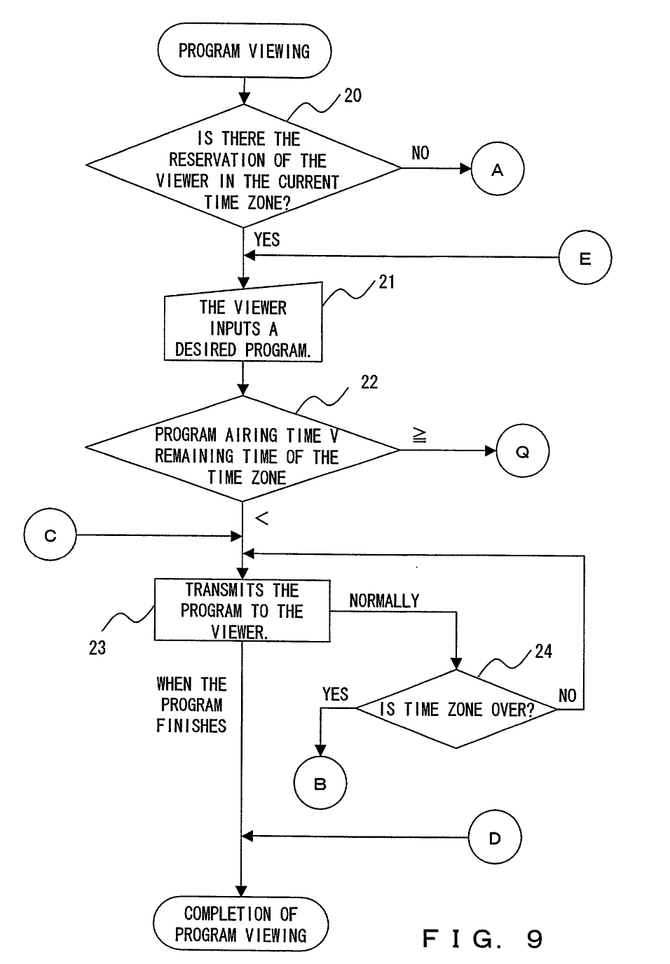

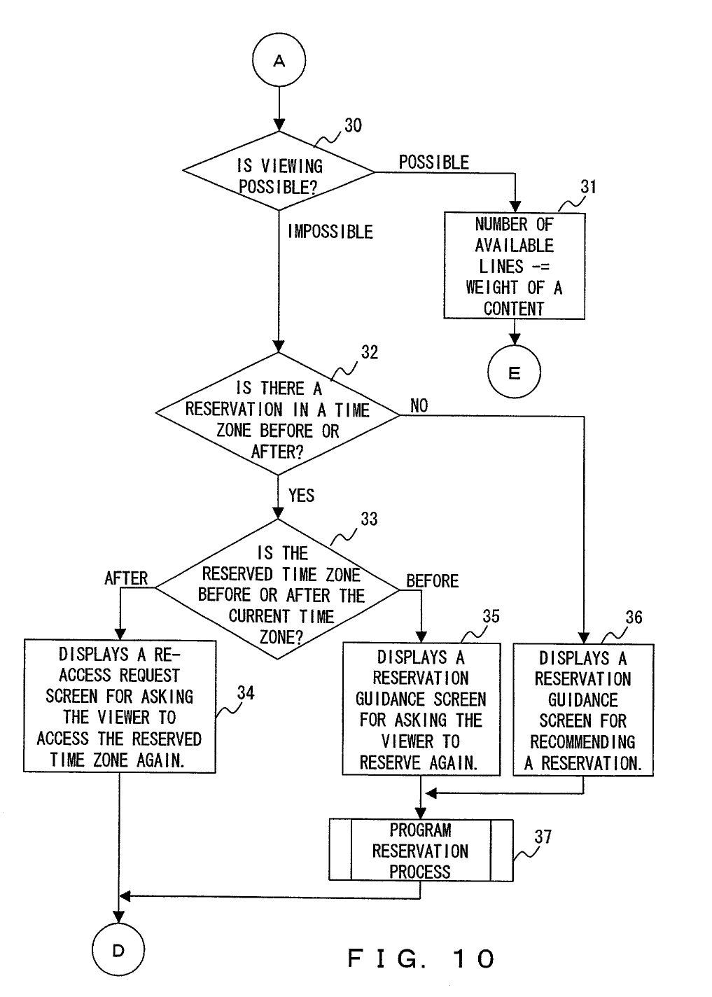

FIG. 9 is a system flowchart showing a process for receiving a request from a viewer that wants to directly view, based on a distribution reservation, which is described later, from a member and enabling the viewer to view a program (content). In FIG. 5, a member is connected to the WWW server unit, which is not shown, in the resource management server 407 from the viewer terminal 404 through the Internet 403, accesses the member information input unit 506 through the WWW server unit, inputs member information and is authenticated by the membership authentication unit 507, based on the input information. If the member is authenticated, the member is connected to the distribution management unit 508. This flow is implemented by the unit 508 running a control program. The functions implemented by this flow correspond to the distribution instructing function described earlier that is provided in the distribution management unit 508.

First, a member clicks a button “Program viewing” on the main screen of the viewer terminal 404 (S1 of FIG. 18, FIG. 19).

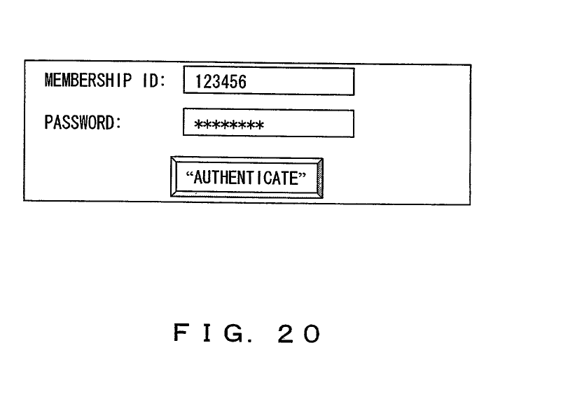

As a result, the member information input unit 506 (FIG. 5) displays a member information input screen on the viewer terminal 404 (S2 of FIG. 18). Then, the member inputs both his/her membership ID and password (FIG. 20), and the membership authentication unit 507 (FIG. 5) authenticates these pieces of member information.

If the member is authenticated, control is transferred to the distribution management unit 508. The distribution management unit 508 confirms the reservation of the connected member in the current time zone in a reservation management table 601 (FIG. 6) (step 20 of FIG. 9, S3 of FIG. 18).

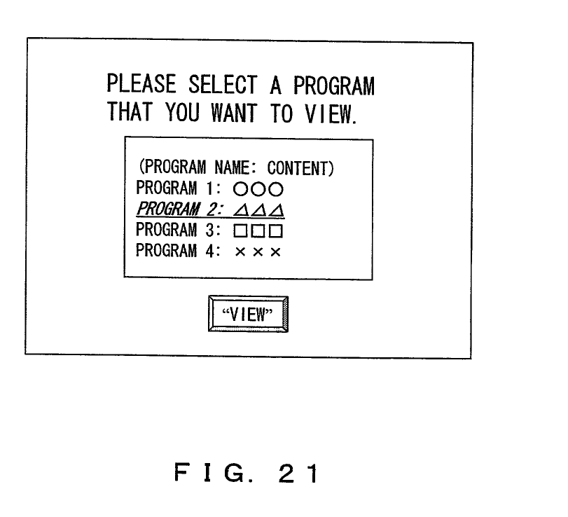

If the reservation is confirmed, the distribution management unit 508 displays a program selection screen for program selection on the viewer terminal 404 (S4 of FIG. 18, FIG. 21) and makes the viewer select a program (step 21 of FIG. 9).

If the viewer selects a program, the distribution management unit 508 compares the airing time of the selected program with the remaining time of the current time zone (step 22 of FIG. 9, S5 of FIG. 18).

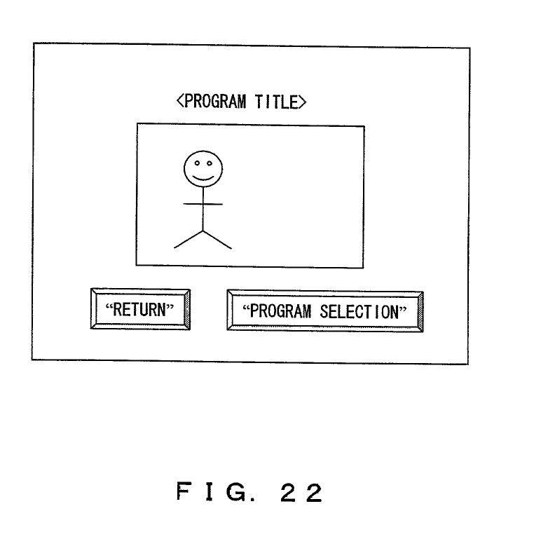

The airing time of the selected program is shorter than the remaining time of the current time zone of the member, the distribution management unit 508 instructs a content server 406 (FIG. 4) of which the unit 508 is in charge to transmit the program to the viewer (step 23 of FIG. 9). As a result, the relevant content server 406 airs the program to the viewer terminal 404 (S6 of FIG. 18, FIG. 22).

Then, until the program finishes (including mid-way finish), the distribution management unit 508 repeats judgment on whether the current time zone of the viewer is over by referring to the reservation management table 601 while instructing the content server 406 to air the program (repetition of steps 23 to 24 to 23 in FIG. 9, repetition of steps S6 to S7 to S6 in FIG. 18).

When the program finishes, the distribution management unit 508 returns to the transmission of the program selection screen (shift S6 to S4 in FIG. 18, FIG. 21).

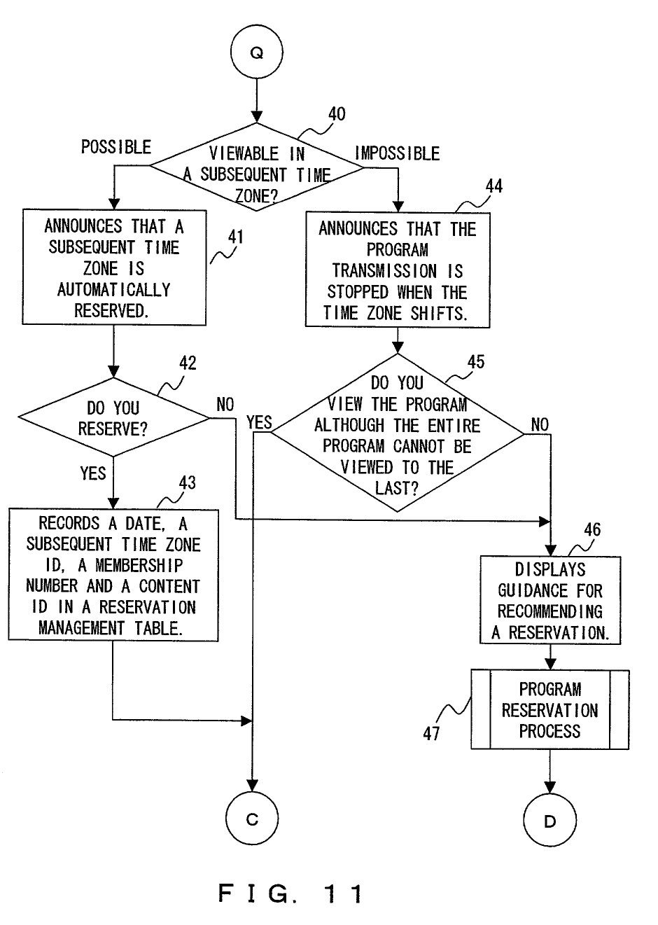

FIG. 10 is a system flowchart showing a process for the distribution management unit 508 enabling a connected member to continue to view the program if it is confirmed that there is no another reservation in the current time zone of the member. The functions implemented by this flow correspond to the shared resource confirmation function, direct viewing permitting function and distribution instructing function described earlier that are provided in the distribution management unit 508 as well as the shared resource utilization amount extraction function and shared resource re-distribution function described earlier that are provided in the shared resource management unit 505.

After the judgment in step 20 of FIG. 9, the distribution management unit 508 first makes an inquiry for the shared resource management unit 505 about whether an unused shared resource is available for both the current time zone and content that are designated by the member. As shown in the system information management table 701 of FIG. 7, the shared resource management unit 505 collects the content of the reservation management table 601 (FIG. 6) that each distribution management unit 508 corresponding to each content server 406 manages, and calculates the number of available lines by subtracting the total of the reserved distribution of each provider from the maximum number of available distribution. The maximum number of available distribution is the number of available distribution that is determined against the capacity of a line connected to the Internet. If in the system information management table 701, the number of available lines of the relevant time zone is greater than 0 and is larger than a weight value extracted from the content information table 602 (FIG. 6) of a content (program) designated by the distribution management unit 508, in response to the inquiry from the distribution management unit 508, the shared resource management unit 505 subtracts the weight value of the content from the relevant number value of available lines in the system information management table 701 and returns a reply that the member can view the program to the distribution management unit 508. Otherwise, the shared resource management unit 505 returns a reply that the member cannot view the program to the distribution management unit 508 (so far steps 30 and 31 of FIG. 9, S8 of FIG. 18).

If the shared resource management unit 505 returns a reply “viewable” to the distribution management unit 508, the unit 508 performs the processes in and after step 21 of FIG. 9 or in and after S4 of FIG. 18, and thereby the viewer can view the program without a reservation if a line is available.

If the shared resource management unit 505 returns a reply “unviewable” to the distribution management unit 508, the unit 508 judges whether the member has a reservation before or after the current time zone by referring to the reservation management table 601 (FIG. 6) (step 32 of FIG. 10).

If the judgment is yes, the distribution management unit 508 further judges whether the time zone that the member has reserved is immediately after or immediately before the current time zone (step 33 of FIG. 10, S9 of FIG. 18).

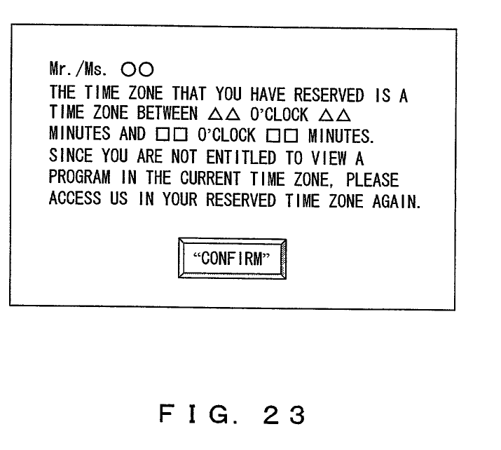

If the time zone that the member has reserved is immediately after the current time zone, the distribution management unit 508 displays a re-access request screen (FIG. 23) for asking the viewer to access the system again in the reserved time zone on the viewer terminal 404 (step 34 of FIG. 10, S10 of FIG. 18).

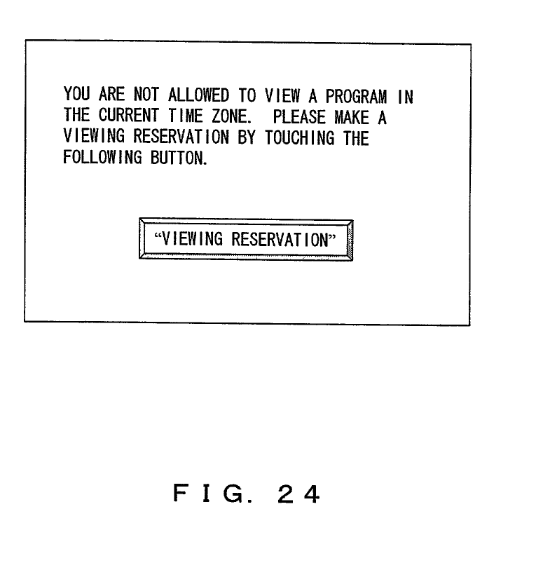

If the time zone that the member has reserved is immediately before the current time zone, the distribution management unit 508 displays a reservation guidance screen for asking the viewer to make a reservation again (FIG. 24, etc.) on the viewer terminal 404 (step 35 of FIG. 10, S11 of FIG. 18).

If the member has no reservation before and after the current time zone, the distribution management unit 508 displays a reservation guidance screen (FIG. 24, etc.) for recommending the viewer to make a reservation on the viewer terminal 404 (step 36 of FIG. 10, S11 of FIG. 18).

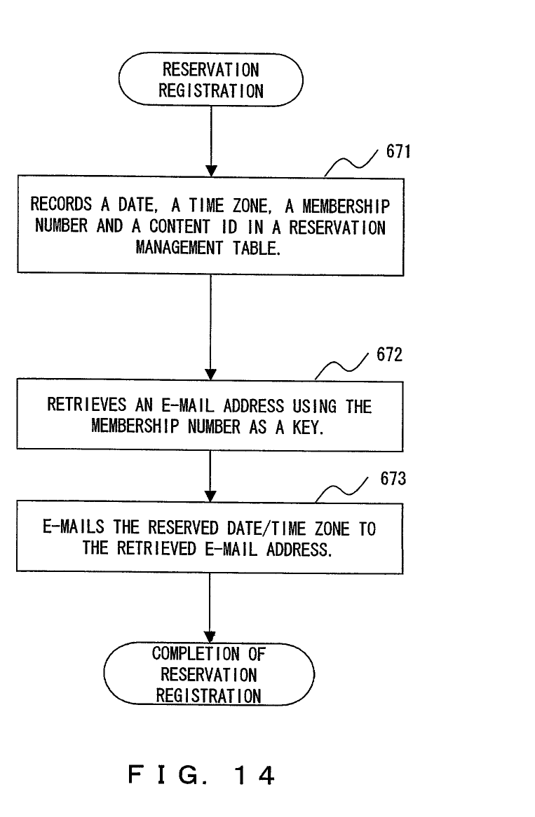

After the display of the reservation guidance screen, the distribution management unit 508 performs the program reservation process shown in FIG. 13, which is described later (step 37 of FIG. 10, S20 to S22 of FIG. 18).

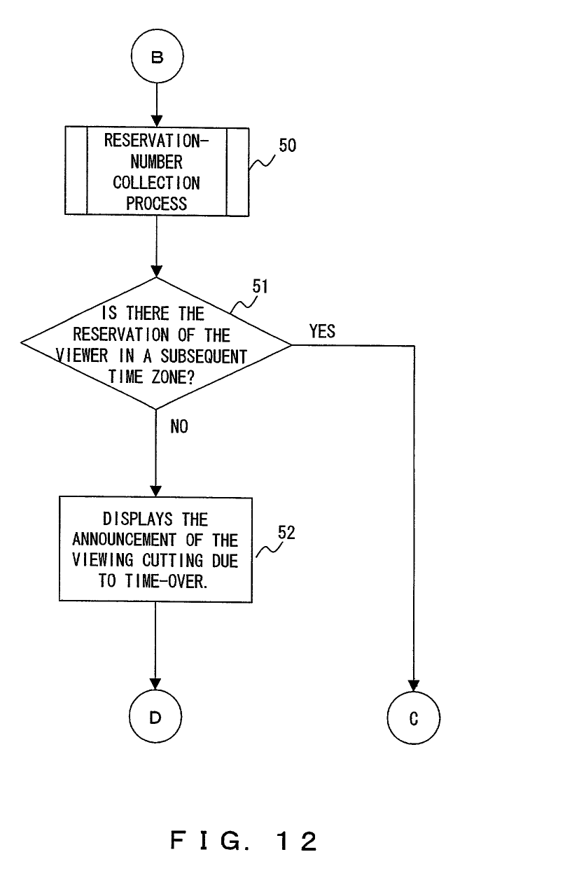

FIG. 11 is a system flowchart showing a process for the distribution management unit 508 enabling a viewer to view a program if in step 22 of FIG. 9 or S5 of FIG. 18, it is judged that the airing time of the selected program is longer than the remaining time of the current time zone of the member, that is, the program does not finish unless the time zone is extended. The functions implemented by this flow correspond to the shared resource confirmation function, direct viewing permitting function and distribution instructing function described earlier that are provided in the distribution management unit 508, and the shared resource utilization amount extraction function, shared resource re-distribution function and distribution reservation management function described earlier that are provided in the shared resource management unit 505.

After the judgment in step 22 of FIG. 9, the distribution management unit 508 first makes an inquiry for the shared resource management 505 about whether an unused shared resource is available for both a time zone following the current time zone and content that are designated by the member. As in the case of step 30 of FIG. 10, in response to the inquiry from the distribution management unit 508, if in the system information management table 701, the number of available lines of the relevant time zone is greater than 0 and is larger than the weight value of a content designated by the distribution management unit 508, the shared resource management 505 returns a reply “viewable” to the distribution management unit 508. Otherwise, the shared resource management unit 505 returns a reply “unviewable” to the distribution management unit 508 (so far step 40 of FIG. 11, S12 of FIG. 18).

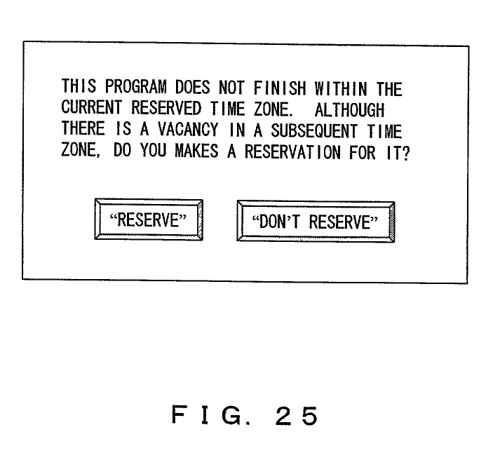

If the shared resource management unit 505 returns a reply “viewable” to the distribution management unit 508, the unit 508 displays a reservation adding notice screen (FIG. 25) for informing that a subsequent time zone can be automatically reserved on the viewer terminal 404 (step 41 of FIG. 11, S13 of FIG. 18).

Then, the distribution management unit 508 judges whether the viewer has selected a button “Reserve” on this screen (step 42 of FIG. 11, S14 of FIG. 18).

If the viewer selects a button “Reserve” on the reservation adding notice screen (FIG. 25), control is transferred from the distribution management unit 508 to a reservation management unit 509, and the unit 509 makes a reservation for the subsequent time zone of the content of the member by recording a date, the number of a time zone following the current time zone designated by the member, his/her membership number and the ID of a content designated by the member in the reservation management table 601 (FIG. 6)(step 43 of FIG. 11).

Then, the distribution management unit 508 moves to the process in step 23 of FIG. 9 described earlier and instructs a content server 406 (FIG. 4) of which the unit 508 is charge to transmit a program to the viewer. As a result, the relevant content server 406 airs the program to the viewer terminal 404 (shift from S14 to S6 in FIG. 18, FIG. 22).

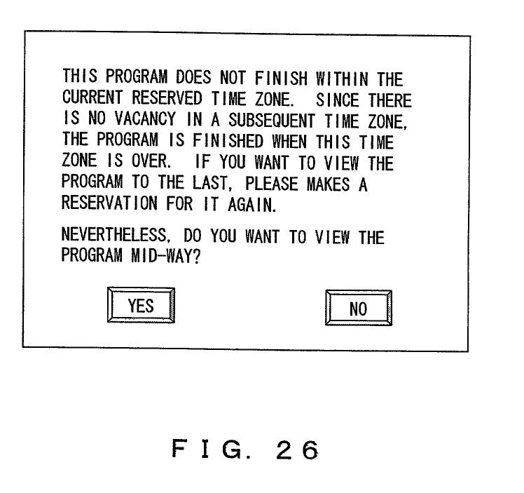

If the shared resource management unit 505 returns a reply “unviewable” to the distribution management unit 508, the unit 508 displays a cutting announcement screen (FIG. 26) for informing that a program transmission is cut when a time zone shifts on the viewer terminal 404 (shift from step 40 to 44 in FIG. 11, shift from S12 to S15 in FIG. 18).

Then, the distribution management unit 508 judges whether the viewer has selected a button “Yes” (to view a program) on this screen (step 45 of FIG. 11, S16 of FIG. 18).

If the viewer selects a button “Yes” on the cutting announcement screen (FIG. 26), the distribution management unit 508 moves to the process in step 23 of FIG. 9 described earlier and instructs the content server 406 (FIG. 4) of which the viewer is in charge to transmit a program to the viewer. As a result, the relevant content server 406 airs the program to the viewer terminal 404 (shift from S14 to S6 in FIG. 18, FIG. 22).

If the viewer selects a button “Don't reserve” on the reservation addition notice screen (FIG. 25) or selects a button “No” on the cutting announcement screen (FIG. 26), the distribution management unit 508 displays a reservation guidance screen (FIG. 24, etc.) for recommending a reservation on the viewer terminal 404 (shift from step 45 to 46 or 42 to 46 in FIG. 11 or shift from S14 to S11 or S16 to S11 in FIG. 18).

After the display of the reservation guidance screen, the distribution management unit 508 performs the program reservation process shown in FIG. 13, which is described later (step 47 of FIG. 11, S20 to S22 of FIG. 18).

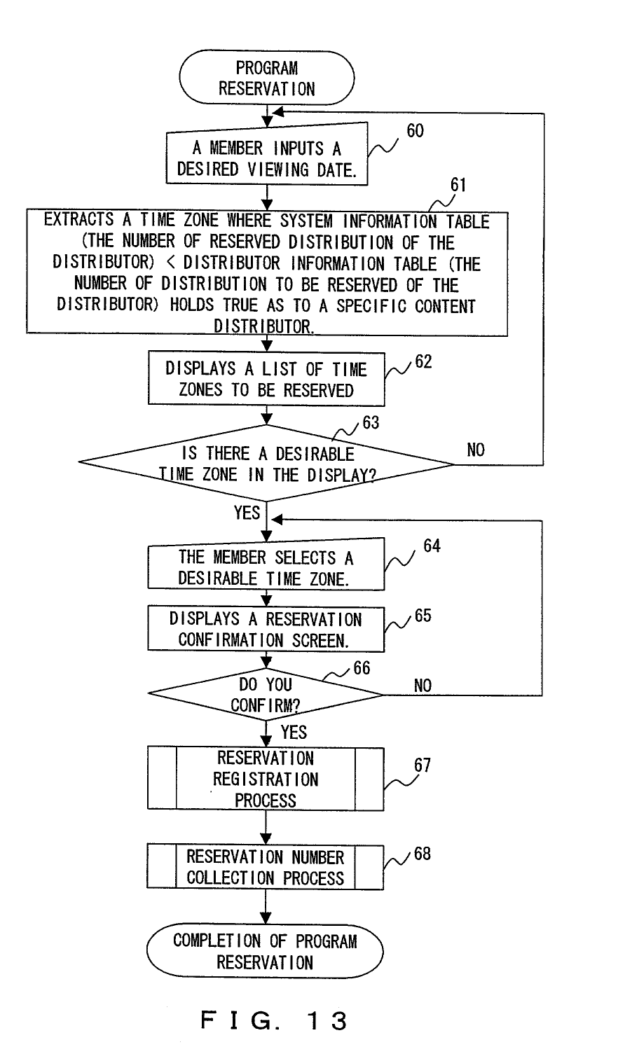

FIG. 12 is a system flowchart showing a process followed in the case where in step S24 of the repetition process of step 23 to 24 to 23 in FIG. 9, the unit 508 judges that the current time zone of the viewer is over. The processes of this system flowchart are followed by the distribution management unit 508 and this system flowchart shows the control over the progress of a program. Functions implemented by this flow correspond to the distribution instructing function provided in the distribution management unit 508.

If the distribution management unit 508 judges that the current time zone of the viewer is over, by referring to the reservation management table 601, the unit 508 first makes the shared resource management unit 505 perform a reservation number collection process (step 50 of FIG. 12).

Then, the distribution management unit 508 judges whether there is the reservation of this member of a program currently aired in a time zone following the current time zone, by referring to the reservation management table 601 (step 51 of FIG. 12, S17 of FIG. 18).

If there is the reservation, the distribution management unit 508 moves to the process in step 23 of FIG. 9 described earlier and instructs the content server 406 (FIG. 4) of which the unit 508 is in charge to continue to transmit the program to the viewer. As a result, the relevant content server 406 continues to air the program to the viewer terminal 404 even in a subsequent time zone (shift from step S14 to S6, FIG. 22).

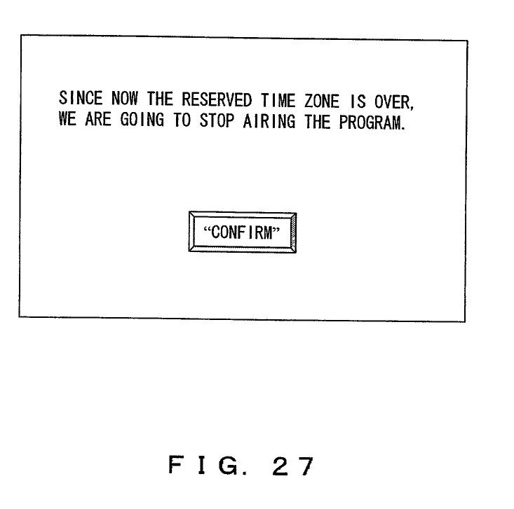

If there is no reservation, the distribution management unit 508 instructs the content server 406 to stop the program and simultaneously makes the viewer terminal 404 display a stoppage screen (FIG. 27) for notifying the viewer of the viewing stoppage due to time-over (step 52 of FIG. 12, S18 of FIG. 18).

If the viewer clicks a button “Confirm”, the screen of the viewer terminal 404 returns to the main screen (FIG. 19).

In FIG. 5, a member is connected to the WWW server unit, which is not shown in FIG. 5, in the resource management server 407 from the viewer terminal 404 through the Internet 403 in FIG. 5. Then, the member accesses the membership information input unit 506 through the WWW server unit. At this moment, the membership information is inputted to the membership information input unit 506. The membership authentication unit 507 authenticates the member based on this membership information. If the member is authenticated, the member is connected to the reservation management unit 509.

FIG. 13 is a system flowchart showing a process for making a member that wants to view reserve a program. This flow is implemented by the reservation management unit 509 performing a control program.

First, a member clicks a button “Viewing reservation” on the main screen of the viewer terminal 404 (S1 of FIG. 18, FIG. 19).

As a result, the member information input unit 506 (FIG. 5) displays a member information input screen on the viewer terminal 404 (S19 of FIG. 18). In response to this display, the member inputs both his/her membership ID and password (FIG. 20), and the membership authentication unit 507 (FIG. 5) checks these pieces of member information.

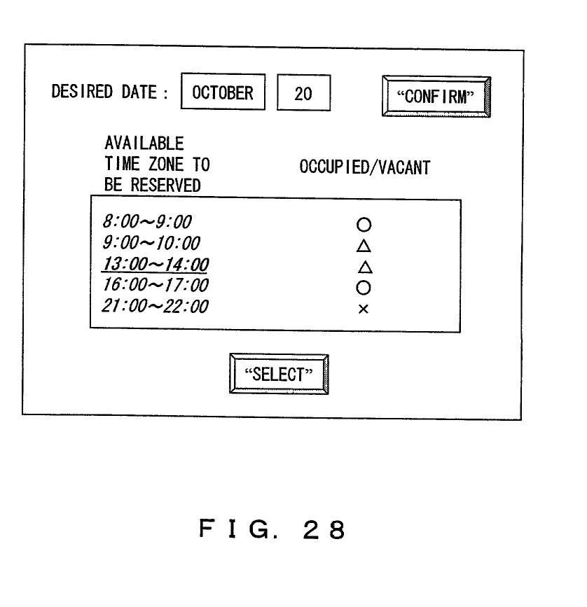

If the member is authenticated, control is transferred to the reservation management unit 509. The reservation management unit 509 first displays a reservation information input screen (FIG. 28) on the viewer terminal 404 (S20 of FIG. 18).

The member first inputs a date when he/she wants to view a program as a desired date and clicks a button “Confirm” (step 60 of FIG. 13, FIG. 28).

The reservation management unit 509 extracts a time zone where the number of reserved distribution of a distributor in the system information management table 701 (FIG. 7) managed by the shared resource management unit 505 is smaller than the number of distribution to be reserved, of the distributor in the distributor information table 603 (FIG. 6) also managed by the shared resource management unit 505 (step 61 of FIG. 13).

Then, the reservation management unit 509 displays a list of available time zones on a reservation information input screen (FIG. 28) of the viewer terminal 404 (step 62 of FIG. 13).

If there is no desired time zone in the screen display, the member inputs a new specific date as a desired date and clicks the button “Confirm” (shift from step 63 to 60 in FIG. 13, FIG. 28).

If there is a desired time zone on the screen display, the member selects the desired time zone from the list and clicks a button “Select” (step 64 of FIG. 13, FIG. 28).

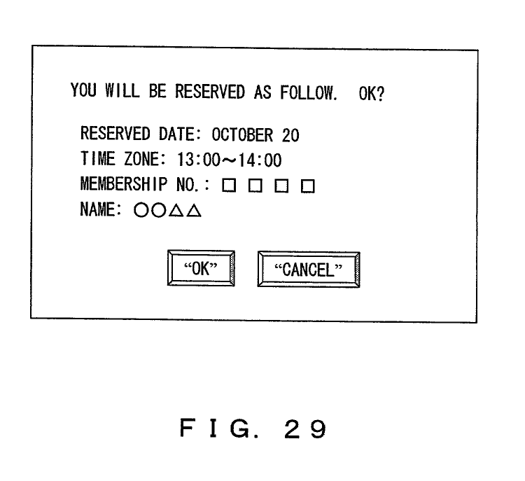

Then, the reservation management unit 509 displays a reservation confirmation screen (FIG. 29) on the viewer terminal 404 (step 65 of FIG. 13, S21 of FIG. 18).

If the member clicks a button “OK” on this screen, the reservation management unit 509 performs a reservation registration process (shift from step 66 to 67 in FIG. 13).

If the member clicks a button “Cancel” on the screen, the reservation management unit 509 displays the reservation information inputting screen on the viewer terminal 404 again and makes the member select a new time zone (shift from step 66 to 64 in FIG. 13).

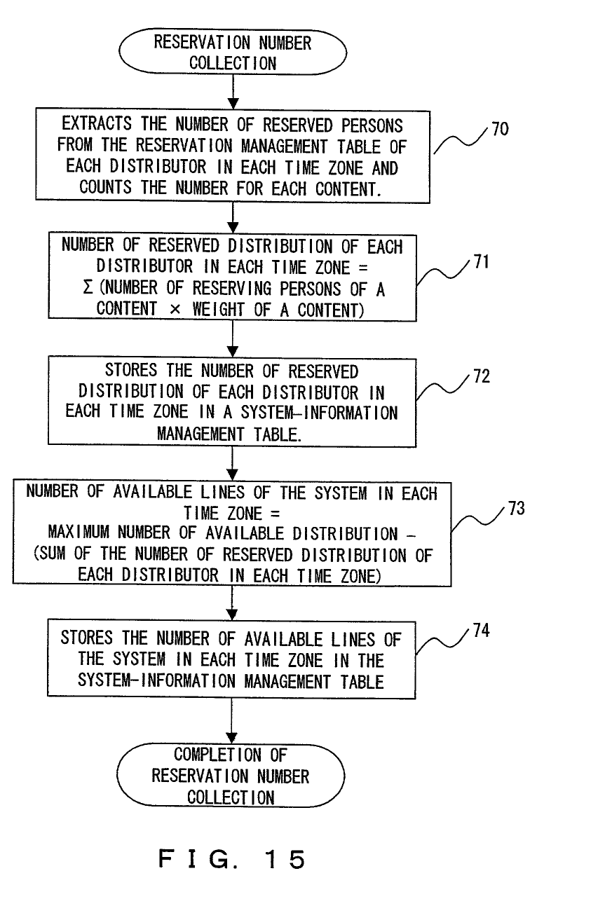

FIG. 14 is a system flowchart showing the reservation registering process in step 67 of FIG. 13.

In FIG. 14, the reservation management unit 509 first records a date, the number of a time zone following the current time zone designated by the member, his/her membership number and the ID of a content designated by the member in the reservation management table 601 (FIG. 6) (step 671 of FIG. 14).

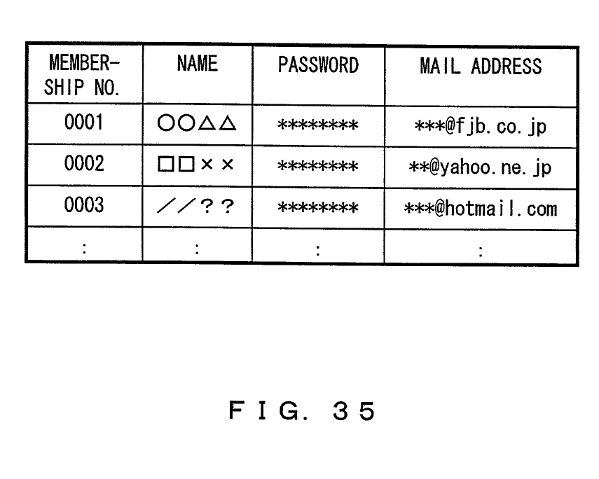

Then, the reservation management unit 509 retrieves the e-mail address of the member from a member management table (see FIG. 35 described later) managed by the membership authentication unit 507 using the membership number inputted by the member in S19 of FIG. 18 (step 672 of FIG. 14).

Then, the reservation management unit 509 e-mails both the reserved date and time zone to the retrieved e-mail address (step 673 of FIG. 14).

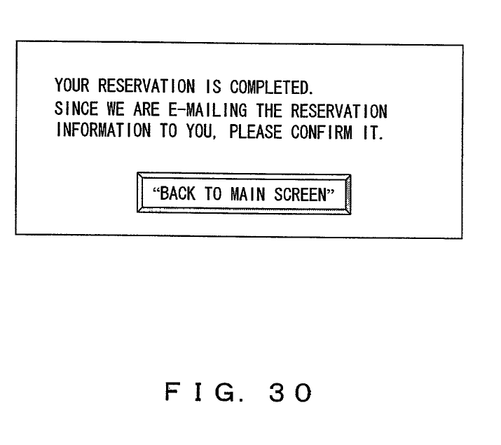

After completing the reservation registration process in step 67 of FIG. 13 in this way, the reservation management unit 509 instructs the shared resource management unit 505 to perform a reservation collection process in order to update the reservation situation (step 68 of FIG. 13) and then displays a reservation completion screen (FIG. 30) on the viewer terminal 404. Then, when the member clicks a button “Back to main screen” (FIG. 30), the screen returns to the main screen (shift from S22 to S1 in FIG. 18).

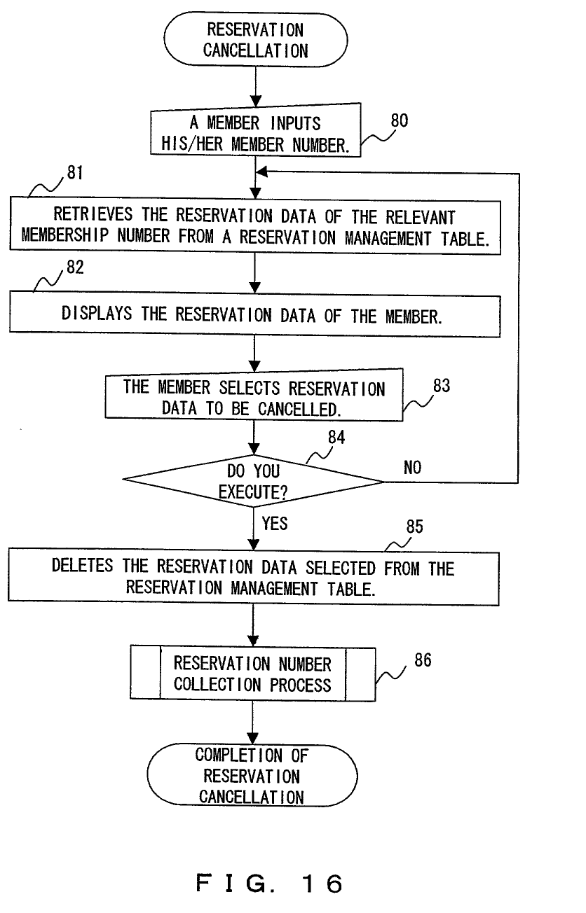

FIG. 15 is a system flowchart showing the reservation number collecting process performed by the shared resource management unit 505 in step 50 of FIG. 12 or step 68 of FIG. 13.

First, the shared resource management unit 505 extracts the number of reserved persons in each time zone from the reservation management table 601 (FIG. 6) of each distributor (provider) managed by the distribution management unit 508 and counts the number for each content (step 70 of FIG. 15).

Then, the shared resource management unit 505 calculates the number of reserved distribution of each distributor in each time zone by summing (the number of content-reserving persons×the weight of a content) (step 71 of FIG. 15).

Then, the shared resource management unit 505 stores the calculated number of reserved distribution of each distributor in each time zone in the system information management table 701 (FIG. 7) (step 72 of FIG. 15).

Then, the shared resource management unit 505 calculates the number of available lines of a system in each time zone as follows (step 73 of FIG. 15).

The maximum number of available distribution −(the sum of the number of reserved distribution of each distributor in each time zone)

Then, the shared resource management unit 505 stores the number of available lines of a system in each time zone calculated in this way in the system information management table 701 (step 74 of FIG. 15).

Thus, the shared resource management unit 505 can obtain the latest reservation situation.

In FIG. 5, a member is connected to the WWW server unit, which is not shown in FIG. 5, in the resource management server 407 from the viewer terminal 404 through the Internet 403 and is finally connected to the reservation management unit 509.

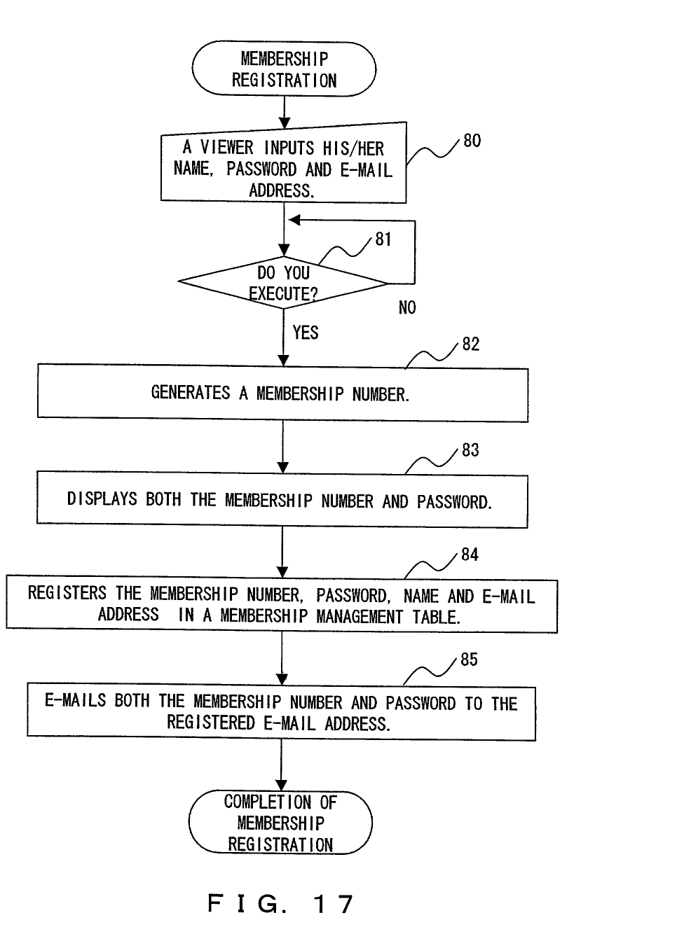

FIG. 16 is a system flowchart showing a process for making a viewer (member) cancel his/her reservation. This flow is implemented by the reservation management unit 509 performing a control program.

First, a member clicks a button “Cancel reservation” on the main screen of the viewer terminal 404 (S1 of FIG. 18, FIG. 19).

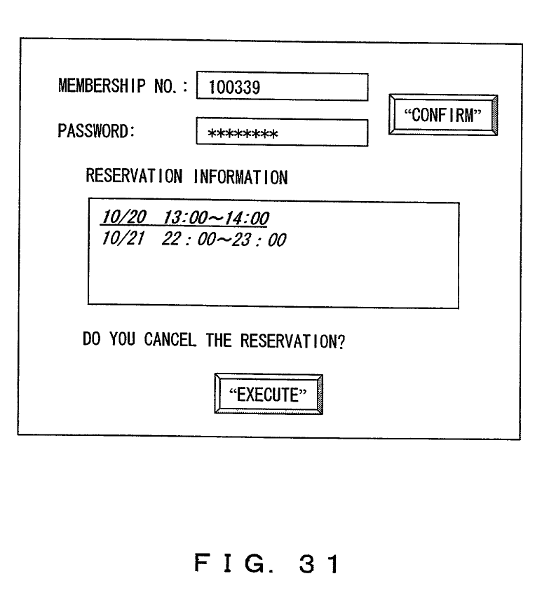

As a result, a reservation cancellation screen (FIG. 31) is displayed on the viewer terminal 404.

The member inputs both his/her membership number and password on this screen and clicks a button “Confirm” (step 80 of FIG. 16).

As a result, these pieces of member information are checked by the membership authentication unit 507 (FIG. 5).

If the member is authenticated, control is transferred to the reservation management unit 509.

The reservation management unit 509 retrieves the reservation data of the relevant membership number from each reservation management table 601 managed by each distribution management unit 508 (step 81 of FIG. 16).

The reservation management unit 509 displays the retrieved reservation data on the reservation cancellation screen (FIG. 31) (step 82 of FIG. 16).

The member selects data to be cancelled from a plurality of the reservation data displayed on the reservation cancellation screen (FIG. 31) and clicks a button “Execute” (step 83 of FIG. 16).

As a result, the reservation management unit 509 deletes the selected reservation data from the reservation management table 601 (shift from step 83 to 84 to 85 in FIG. 16).

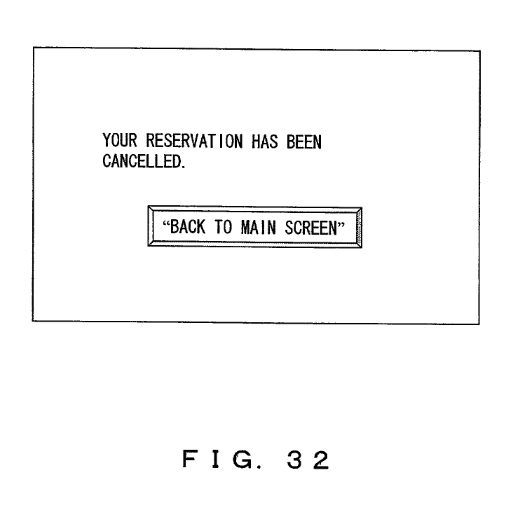

Then, to update the reservation situation, the reservation management unit 509 instructs the shared resource management unit 505 to perform the reservation collection process described earlier with reference to FIG. 15 (step 68 of FIG. 13), displays a reservation cancellation confirmation screen (FIG. 32) on the viewer terminal 404. Then, the screen returns to the main screen when the member clicks a button “Back to main screen” (FIG. 32) (shift from S24 to S1 in FIG. 18).

In FIG. 5, a member is connected to the WWW server unit, which is not shown in FIG. 5, in the resource management unit 407 from the viewer terminal 404 through the Internet 403 and is finally connected to the member information input unit 506.

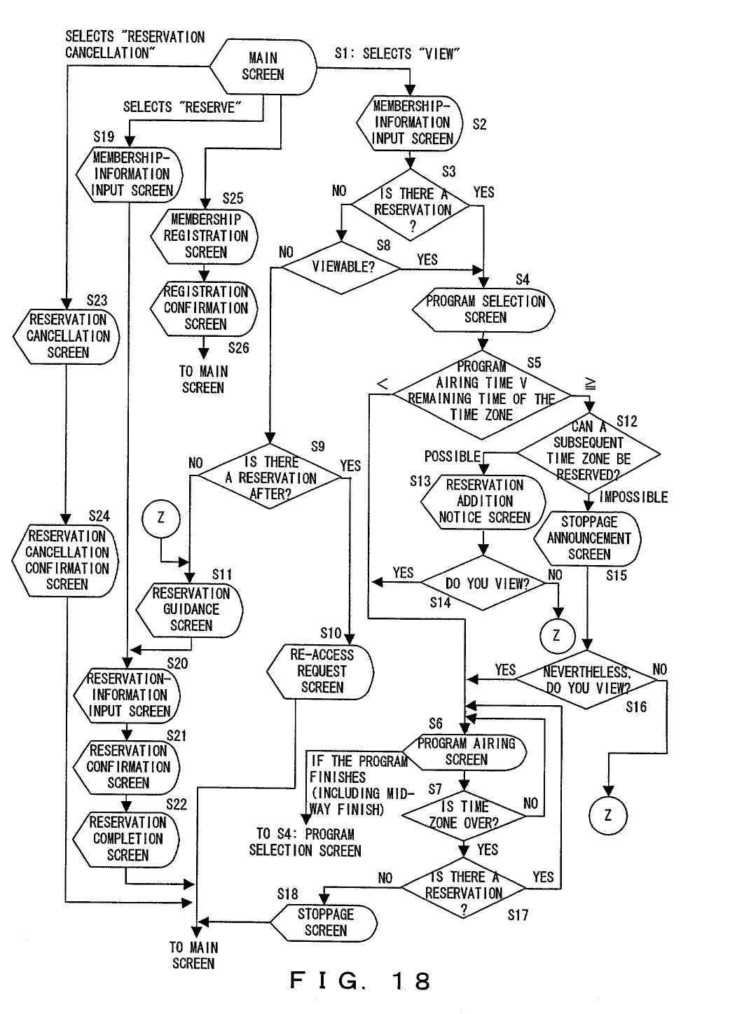

FIG. 17 is a system flowchart showing a process for registering members. This flow is implemented by the member information input unit 506 performing a control program.

First, a member candidate clicks a button “Membership registration” on the main screen of the viewer terminal 404 (S1 of FIG. 18, FIG. 19).

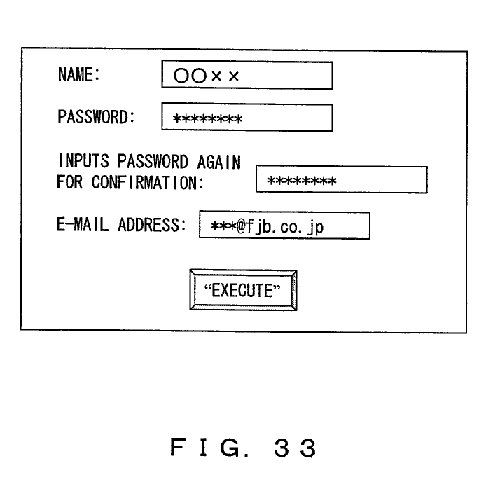

As a result, the member information input unit 506 displays a membership registration screen (FIG. 33) on the viewer terminal 404.

The member candidate inputs his/her name, password and e-mail address on this screen and clicks a button “Execute” (shift from step 80 to 81 in FIG. 17).

The member information input unit 506 generates a membership number (step 82 of FIG. 17).

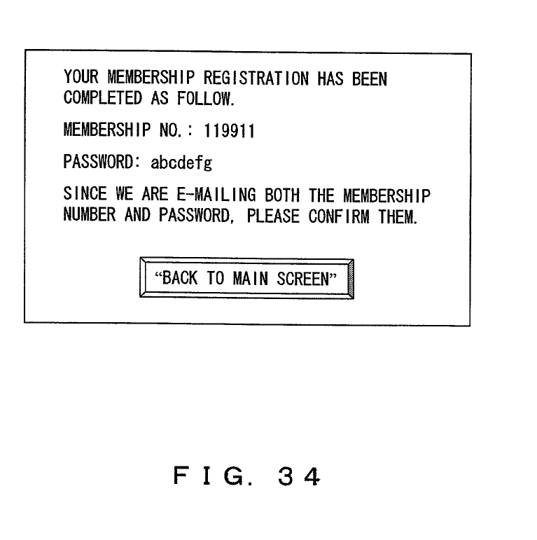

Then, the member information input unit 506 displays a registration confirmation screen (FIG. 34) for displaying both a membership number and password on the viewer terminal 404.

The member information input unit 506 registers his/her membership number, password, name and e-mail address in a membership management table with the data structure shown in FIG. 35 (step 84 of FIG. 17).

Lastly, the member information input unit 506 e-mails both the membership number and password to the registered e-mail address (step 85 of FIG. 17).

When the new member clicks a button “Back to main screen” (FIG. 34), the screen returns to the main screen (shift from step S26 to S1 in FIG. 18).

Although in the preferred embodiment described above, a form is described where a viewer always performs membership registration and then receives services, the present invention is not limited to this form. For example, a form can also be considered where a viewer receives a reservation ID every time the viewer reserves a program and uses services. The operation of the form where a viewer receives this reservation ID and uses services is described below.

First, the screen transition diagram corresponds to FIG. 18 of the preferred embodiment described earlier, and the same reference numbers have the same functions as those shown in FIG. 18.

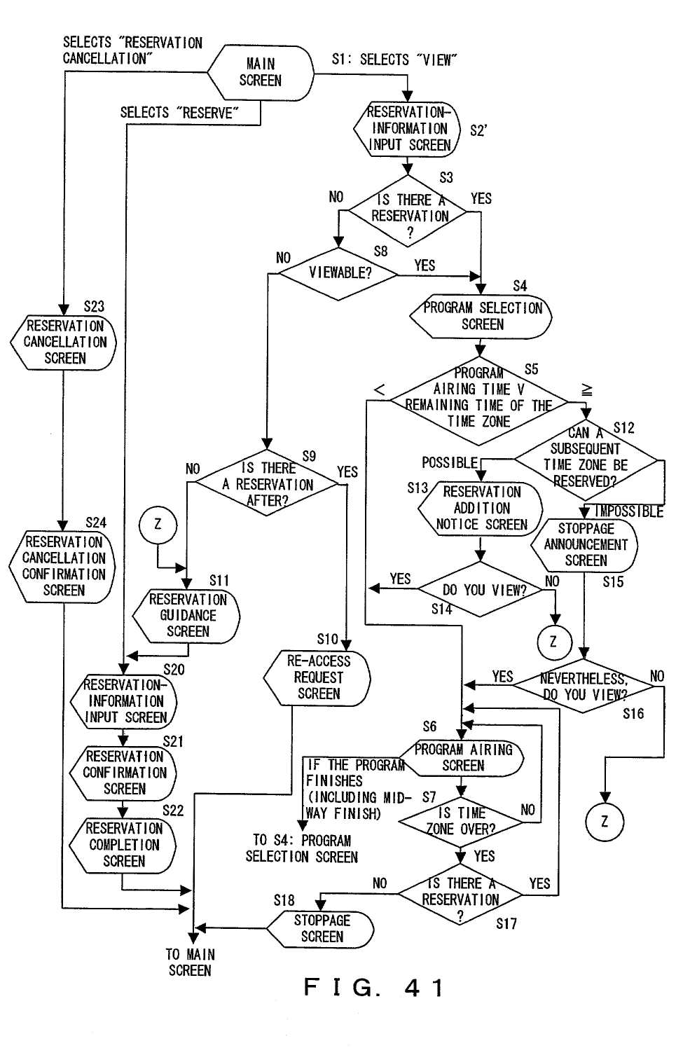

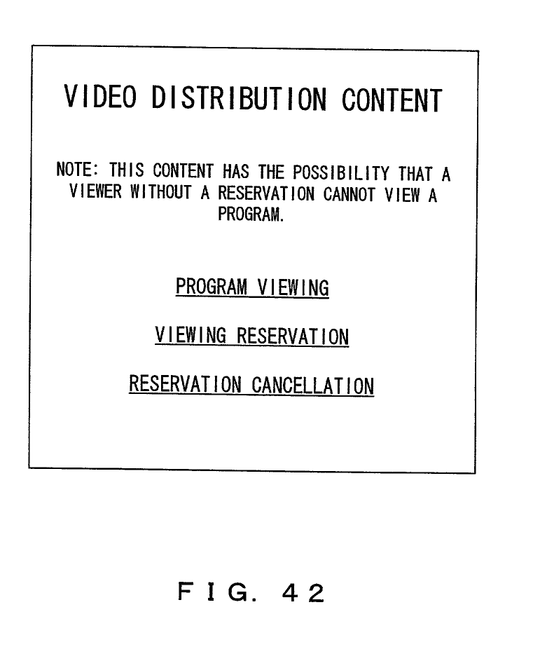

FIG. 41 differs from FIG. 18 only in that the processes S25 and 26 required to register members in FIG. 18 are unnecessary and that the input operation S2 of member information is replaced with the input operation S2′ of reservation information. Accordingly, as shown in FIG. 42, there is no menu of membership registration on the main screen when compared with FIG. 19 of the preferred embodiment described above.

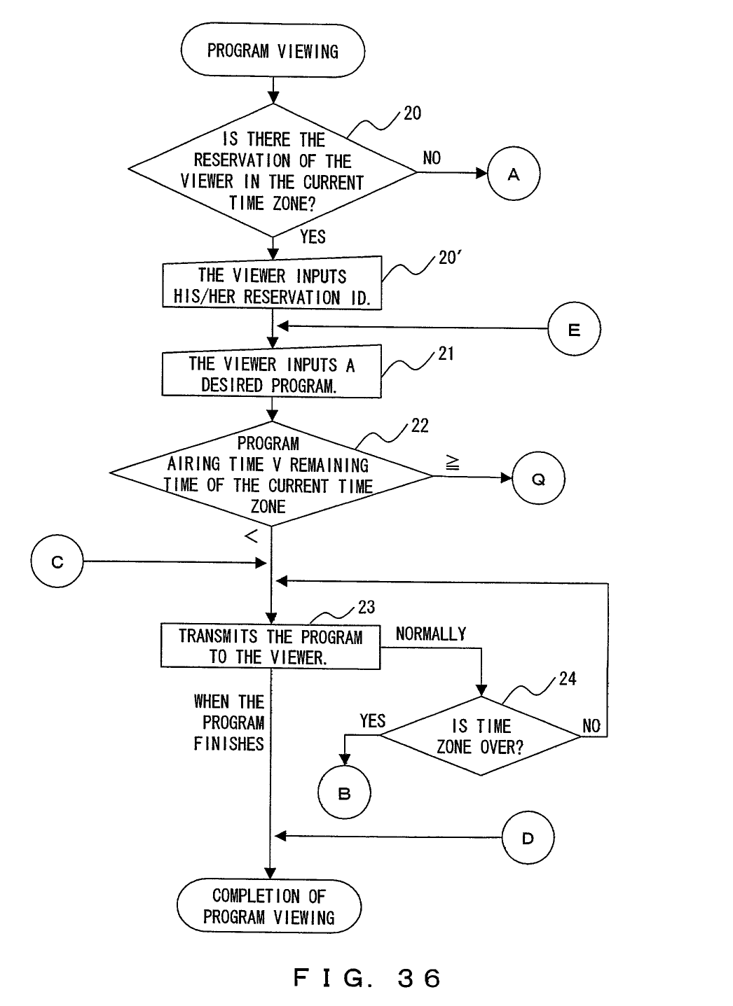

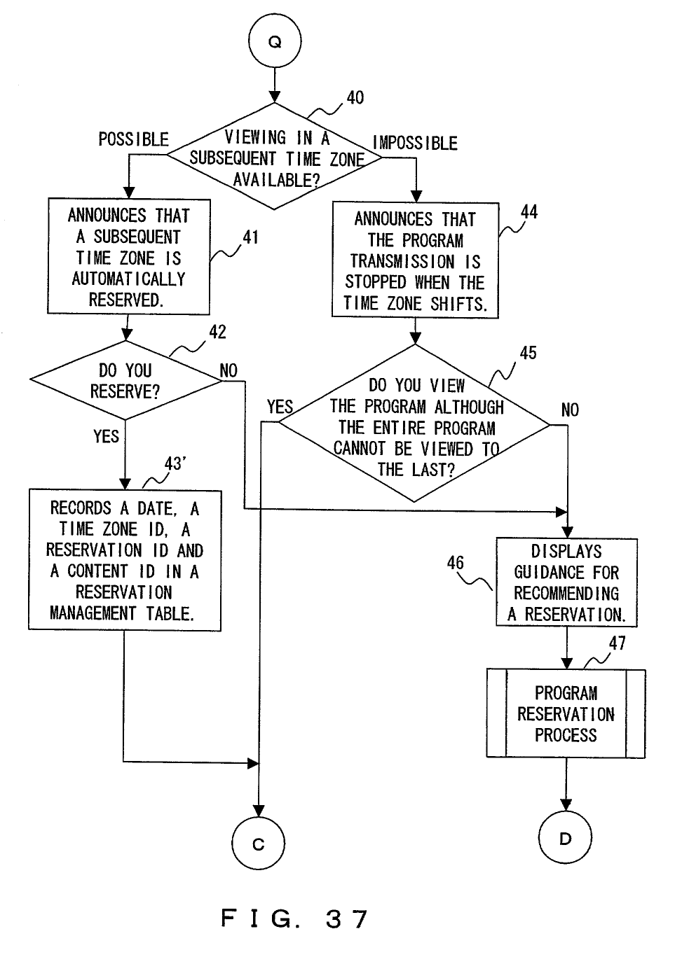

FIG. 36 corresponds to FIG. 9 of the preferred embodiment described earlier.

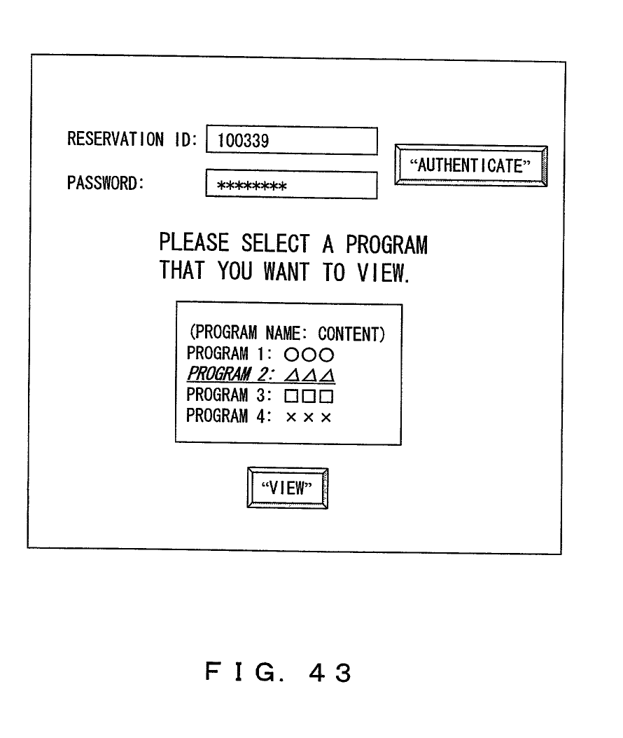

FIG. 36 differs from FIG. 9 in that the input operation (step 20′) of a reservation ID by a viewer is added. Accordingly, as shown in FIG. 43, the input items of a reservation ID and password are added to the program selection screen when compared with FIG. 21 of the preferred embodiment described earlier. The input screen (FIG. 20) for inputting member information in advance that is required in the preferred embodiment described earlier also is unnecessary.

FIG. 10 of the preferred embodiment described earlier also applies to this preferred embodiment.

FIG. 37 corresponds to FIG. 11 of the preferred embodiment described earlier.

FIG. 37 differs from FIG. 11 in that of the registration items of a reservation management table in the case of automatic reservation, the registration of a membership number is replaced with the registration of a reservation ID (step 43′).

FIG. 12 of the preferred embodiment described earlier also applies to this preferred embodiment.

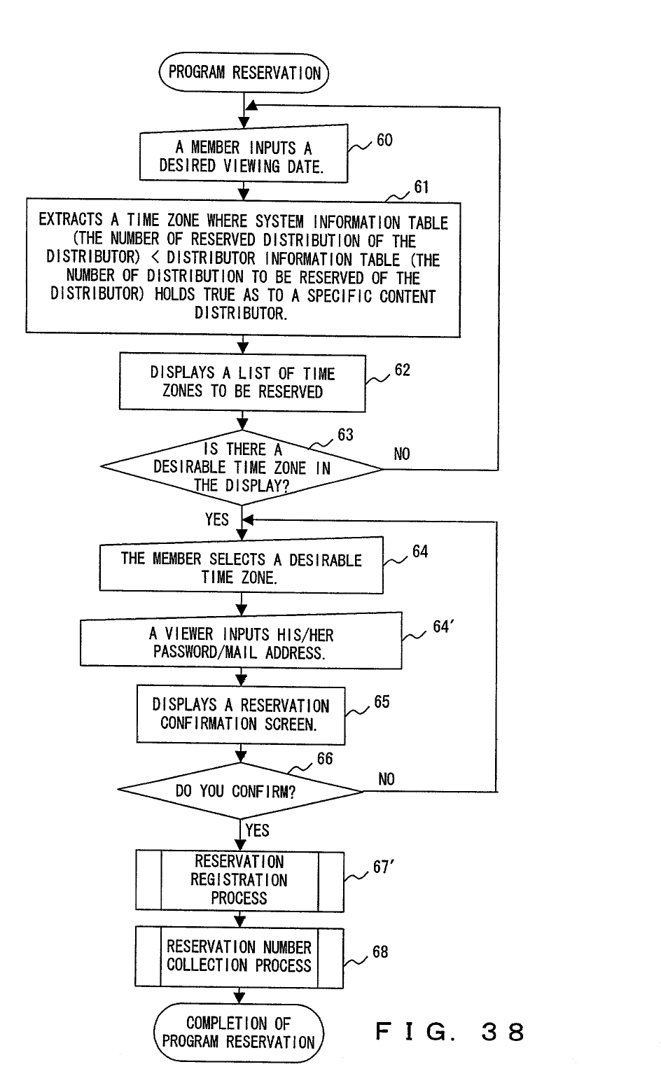

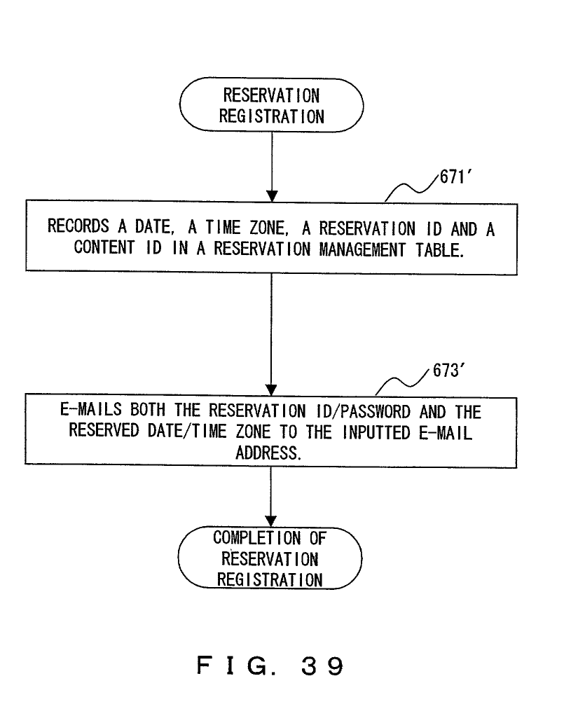

FIGS. 38 and 39 correspond to FIGS. 13 and 14, respectively, of the preferred embodiment described earlier.

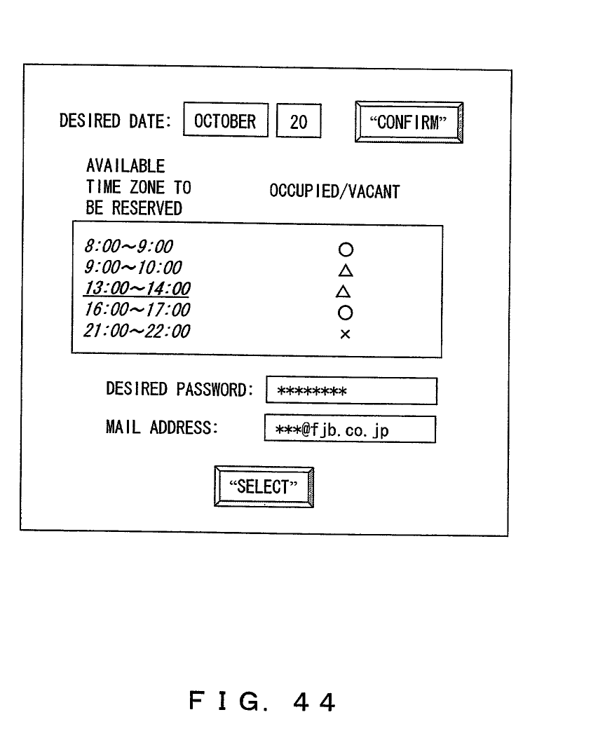

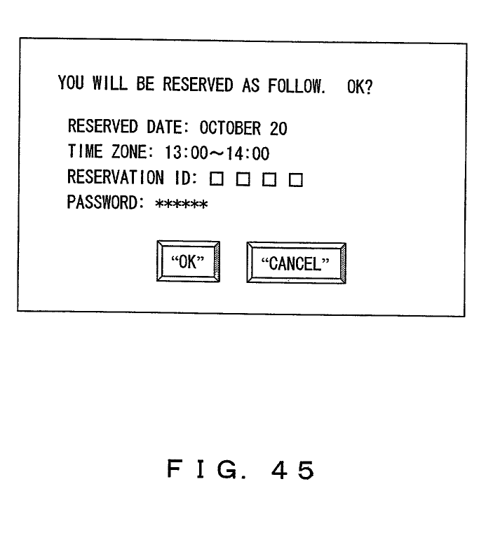

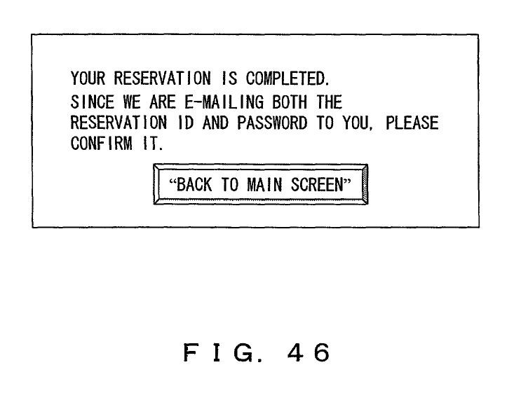

FIGS. 38 and 39 differ from FIGS. 13 and 14, respectively, in that a viewer inputs both his/her desired password and e-mail address when the viewer reserves a program (step 64′), that of the reservation items of a reservation management table, the registration of a membership number is replaced with the registration of a reservation ID (step 671′), that the process of retrieving a e-mail address using a membership number as a key (step 672) is deleted (because the e-mail address is inputted in step 64′) and that not only a reserved date and a time zone, but also the reservation ID and password that are inputted are transmitted to the inputted e-mail address (step 673′) Accordingly, as shown in FIGS. 44 through 46, information items, such as a reservation ID, a password, an e-mail address and the like, are added to a reservation information input screen, a reservation confirmation screen and a reservation completion screen when compared with FIGS. 28 through 30, respectively.

FIG. 15 of the preferred embodiment described earlier also applies to this preferred embodiment.

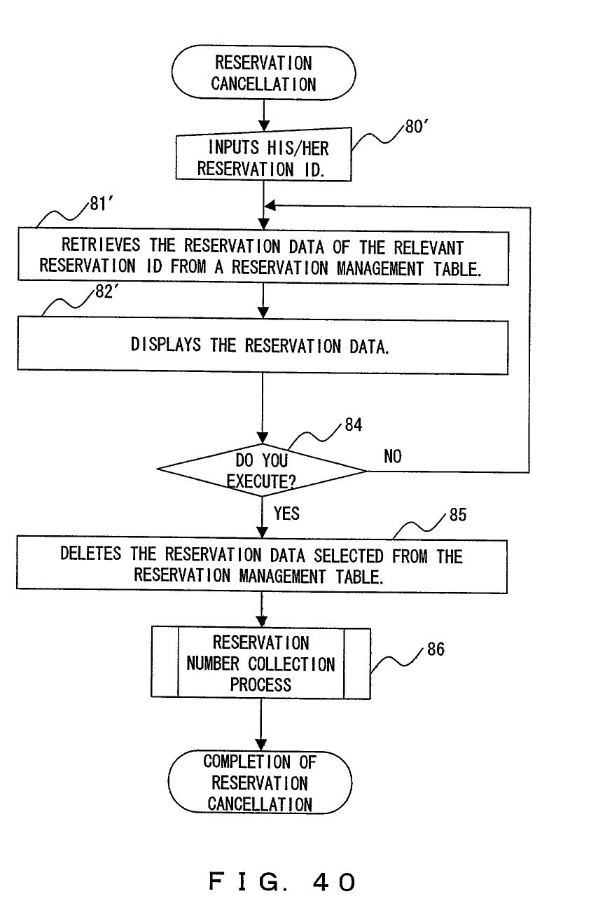

FIG. 40 corresponds to FIG. 16 of the preferred embodiment described earlier.

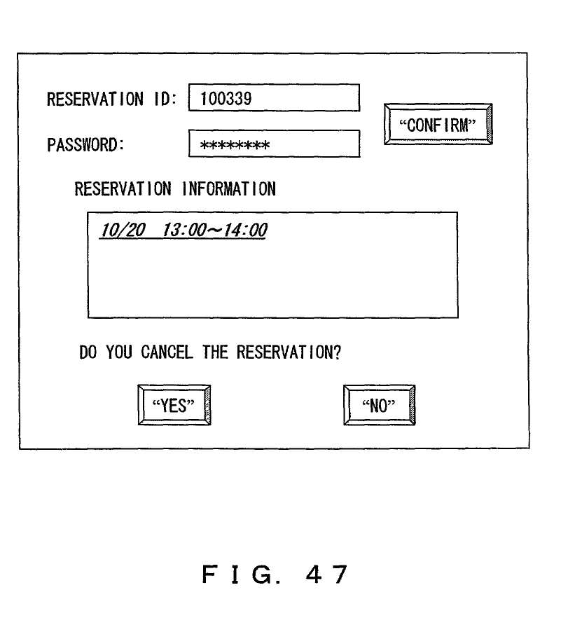

FIG. 40 differs from FIG. 16 in that a viewer inputs his/her reservation ID instead of his/her membership number when the viewer cancels a reservation (step 80′), that reservation data that are cancelled in a reservation management table based on the reservation ID, are directly retrieved and displayed (steps 81′ and 82′) and that a process (step 83) where the viewer selects reservation data is unnecessary. Accordingly, as shown in FIG. 47, the designation items of a membership number and a password are replaced with the designation items of a reservation ID and a password on a reservation cancellation screen when compared with FIG. 31 of the preferred embodiment described earlier, and only one piece of reservation data is displayed.

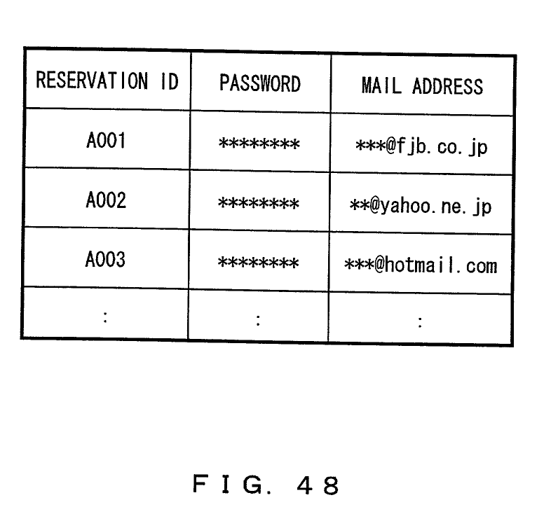

In this preferred embodiment, the reservation ID management table shown in FIG. 48 is used instead of the member management table shown in FIG. 35 of the preferred embodiment described earlier.

The resource management server 407 is implemented by a computer system. A program for implementing a variety of function of the preferred embodiment of the present invention is stored in the storage medium of this computer system. The program is read from this storage medium and run, as required. Alternatively, the program for implementing the variety of functions can also be extracted and run from a communications network connected to this resource management server 407.

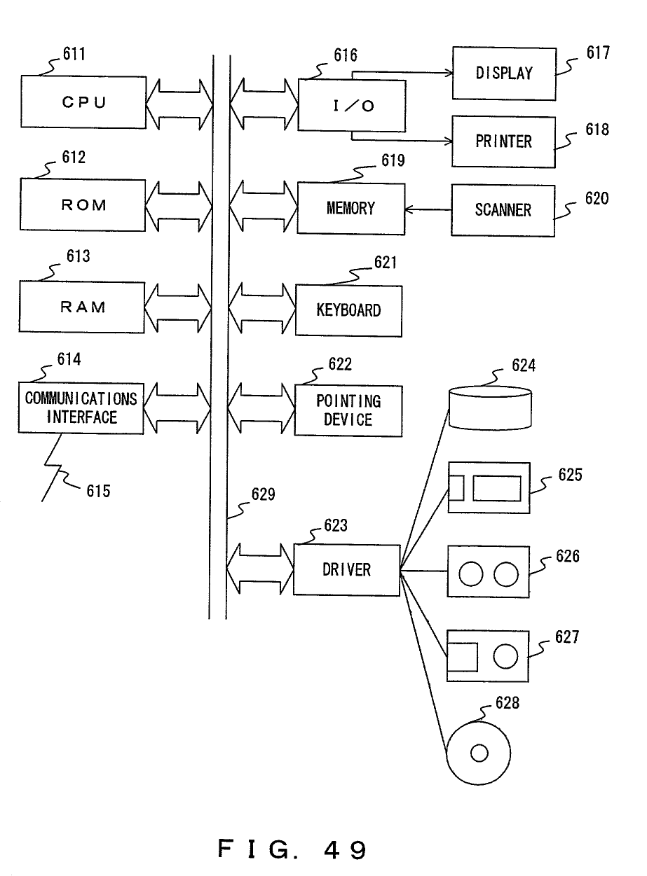

FIG. 49 shows a case where such a resource management server 407 is used. In FIG. 49, a central processing unit (CPU) for performing an overall process, a read-only memory (ROM), a random-access memory (RAM), a communications interface, a communications network, an input/output interface, a display for displaying communications data and the like, a printer for printing communications results, a memory for temporarily storing data read by a scanner, a scanner for reading communications data, a keyboard for inputting a password and the like, a pointing device, such as a mouse, a driver for driving a storage medium, a removable hard disk, an IC memory card, a magnetic tape, a floppy disk, an optical disk, such as a CD-ROM, DVD-ROM, and a bus are represented by 611, 612, 613, 614, 615, 616, 617, 618, 619, 620, 621, 622, 623, 624, 625, 626, 627, 628 and 629, respectively.

A program for implementing each function of the preferred embodiment of the present invention is stored in, for example, the floppy disk 627, the optical disk 628, such as a CD-ROM, a portable storage medium, such as the removable hard disk 624, and the ROM 612. By reading the program into the RAM 613 from these storage media, each of the functions described above can be controlled.

Furthermore, the program for implementing each of the functions described above can also be extracted from the communications network 615 through the communications interface 614.

In this case, the resource management server 407 generates a carrier signal for carrying a program and data, and transmits the signal to an information-processing device through an arbitrary transmission medium in the network. The CPU 611 performs necessary processes using the data and running the program.

For the communications network 615 connected to the communications interface 614, a LAN (Local Area Network), a WAN (Wide Area Network), the Internet, a analog telephone network, a digital telephone network (ISDN (Integral Service Digital Network)) and a wireless communications network, such as a PHS (Personal Handy System), satellite communications can be used.

When the features of the preferred embodiment of the present invention described so far are as follows.

A content provider (distributor) has the following effects.

(1) Since the number of distribution to be reserved is set in each time zone and a reservation function is used, contents can be stably operated.

(2) Since a viewer without a reservation can also use contents and can receive reservation guidance by the check of the number of available lines of the entire system, the improvement of the satisfaction degree of a user can be expected.

(3) The utilization analysis of contents can be simplified by specifying the number of distribution to be reserved in each time zone.

A viewer has the following effects.

(1) A viewer can immediately view a program without a reservation if there is room in the utilization situation of the system. If there is no room in the utilization situation, a vacant time zone can be checked and reserved. Therefore, serviceability is high.

(2) If a utilization time is reserved in advance, the system can be used without fail. Therefore, there is no need for a viewer to worry about the availability of the system.

(3) Even if the airing time of a content to be used is longer the reserved time zone, the content can continue to be used to the last if there is room in the reservation situation of a subsequent time zone of the system.

A service provider has the following effects.

(1) Services can be most efficiently provided for a content provider.

(2) Since a content provider can freely determine the content of a content to be actually operated, this content provision can be applied to a variety of cases. This leads to the expansion of a business opportunity.

In this way, according to the present invention, shared resources in a shared media distribution service can be efficiently utilized. In this case, secure media distribution can be guaranteed by making a viewer candidate reserve a program. Thus, even if there are more distribution requests than set in advance, the number of media content distribution can be increased within some limits and cost performance can be improved to the utmost accordingly.

What is claimed is:

1. A media-distribution-resource management apparatus which is a resource-shared media-distribution-resource management apparatus using a network, comprising:
a resource-utilization-information management unit managing shared-resource information about both available network resources and available media-distribution-system resources;
a shared-resource management unit distributing or re-distributing the shared resources based on a resource utilization request from each content distributor;
a distribution management unit which is provided in each media distribution server and which performs both reservation management and distribution management of media distribution in each of the media distribution servers within a scope of a utilization right distributed or re-distributed by the shared-resource management unit;
a distributor management unit managing information about a media distributor that wants to use the shared resources; and
a viewer management unit managing information about a viewer.

2. The media-distribution-resource management apparatus according to claim 1, wherein
said resource-utilization-information management unit, comprising:
a server-resource management unit managing resource information about a media-distribution server; and
a network-resource management unit managing information about network resources for media distribution.

3. The media-distribution-resource management apparatus according to claim 1 or 2, wherein
said shared-resource management unit, comprising:
a resource-utilization-information extraction unit extracting available resource information from said resource-utilization-information management unit; and
a shared-resource-availability display unit displaying information about available shared resources for a media distributor;
a resource-utilization-information input unit the media distributor inputting a resource utilization request;
a shared-resource distribution unit distributing a utilization right of the shared resource in a specific time period to said distribution management unit installed in each of the media distributors based on information that is obtained in each time zone by the resource-utilization-information extraction unit and resource-utilization-information input unit;
a shared-resource-utilization amount extraction unit extracting a utilization situation of the shared resource in a specific time period; and
a shared-resource re-distribution unit redistributing a utilization right of an unused one of the shared resources to said distribution management unit based on both the utilization situation and distribution request in a specific time period extracted by said distribution management unit.

4. The media-distribution-resource management apparatus according to one of claims 1 through 3, wherein
said distribution management unit, comprising:
an available reservation-candidate display unit displaying available content candidates to be reserved within a scope of a utilization right distributed by said shared-resource management unit;
a distribution-reservation input unit making a viewer select at least one content to be distributed out of the displayed candidates;
a distribution-reservation management unit reserving distribution for a viewer based on the selection made by the viewer from the displayed candidates;
a direct viewing reception unit making a viewer candidate without a reservation within a media distribution time;
a shared-resource confirmation unit making an inquiry for said shared-resource management unit about whether an unused one of the shared resources is available, based on the selection made by the viewer from the displayed candidates;
a direct-viewing permitting unit permitting viewing within the media distribution time based on the utilization right re-distributed by said shared-resource management unit; and
a distribution-instructing unit instructing the media distribution server to perform media distribution to a viewer that is permitted to receive direct distribution out of both viewers with the reservation of media distribution and viewer candidates without reservations.

5. The media-distribution-resource management apparatus according to one of claims 1 through 4, wherein
said distributor management unit, comprising:
a distributor-information input unit making a media distributor that wants to use the shared resource input information about the distributor itself; and
a distributor authentication unit authenticating the media distributor based on the shared resource input information.

6. The media-distribution-resource management apparatus according to one of claims 1 through 5, wherein
said viewer management unit, comprising:
a viewer-information input unit inputting information about a viewer candidate; and
a viewer authentication unit authenticating the viewer candidate based on the input information.

7. A computer-readable storage medium which records a program for enabling a computer to perform a function when the program is read by the computer, the function comprising:
a resource-utilization-information management function to manage shared-resource information about both an available network resource and an available media-distribution-system resource;
a shared-resource management function to distribute or re-distribute the shared resource based on a resource-utilization request from each content distributor;
a distribution management function which is provided in each media distribution server and which performs both reservation management and distribution management of media distribution for each of the media distribution servers within a scope of a resource-utilization right distributed or re-distributed by the shared-resource management function;
a distributor management function to manage information about media distributors that want to use the shared resource;
a viewer management function to manage information about viewers.

8. A media-distribution-resource management apparatus which is a resource-shared media-distribution-resource management apparatus using a network, comprising:
resource-utilization-information management means for managing shared-resource information about both available network resources and available media-distribution-system resources;
shared-resource management means for distributing or re-distributing the shared resources based on a resource utilization request from each content distributor;
distribution management means which is provided for each media distribution server and which performs both reservation management and distribution management of media distribution for each of the media distribution servers within a scope of a utilization right distributed or re-distributed by the shared-resource management means;
distributor management means for managing information about a media distributor that wants to use the shared resources; and
viewer management means managing information about viewers.

9. A carrier signal which carries to a computer a program for enabling the computer to perform a function when the program is read by the computer, the function comprising:
a resource-utilization-information management function to manage shared-resource information about both an available network resource and an available media-distribution-system resource;
a shared-resource management function to distribute or re-distribute the shared resource based on a resource-utilization request from each content distributor;
a distribution management function which is provided in each media distribution server and which performs both reservation management and distribution management of media distribution for each of the media distribution servers within a scope of a resource-utilization right distributed or re-distributed by the shared-resource management function;
a distributor management function to manage information about media distributors that want to use the shared resource;
a viewer management function to manage information about viewers.
